(19) United States
(12) Patent Application Publication
(10) Pub. No.: US 2025/0175571 A1
(43) Pub. Date: May 29, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: AKITOSHI YAMADA, Kanagawa (JP); MASAO KATO, Kanagawa (JP); KOUTA MURASAWA, Kanagawa (JP)

(21) Appl. No.: 18/957,482

(22) Filed: Nov. 22, 2024

(30) Foreign Application Priority Data
Nov. 28, 2023 (JP) 2023-201023

(51) Int. Cl. H04N 1/60

(52) U.S. Cl. CPC H04N 1/60

(57) ABSTRACT

An obtaining unit obtains first color information. A setting unit sets second color information indicating particular color information. A conversion unit executes color conversion processing for converting the first color into a third color and the second color into a fourth color. a first correction unit configured to, in a case where the first color is not included in the particular color information, corrects a conversion parameter in the color conversion processing such that a color obtained by converting the first color is a fifth color, and, in a case where the first color is included in the particular color information, corrects a conversion parameter in the color conversion processing such that a color obtained by converting the second color is a sixth color.

### BACKGROUND

### Field

The present disclosure relates to an information processing apparatus, an information processing method, and a storage medium.

### Description of the Related Art

Information processing apparatuses that receive a digital original described in a predetermined color space, map each color in that color space to a color gamut that can be reproduced by a printer, and output the result are known. Japanese Patent Laid-Open No. 2020-27948 describes “perceptual” mapping and “absolute colorimetric” mapping. In addition, Japanese Patent Laid-Open No. H07-203234 describes determining whether to compress the color space and the direction of compression for inputted color image signals.

### SUMMARY

According to some embodiments of the present disclosure, an information processing apparatus includes an obtaining unit configured to obtain first color information from an image that includes a pixel representing color information of a first color defined in a first color gamut and a pixel representing color information of a second color defined in the first color gamut; a setting unit configured to set second color information indicating particular color information; a conversion unit configured to execute, on the image, color conversion processing for converting the first color into a third color defined in a second color gamut and converting the second color into a fourth color defined in the second color gamut; and a first correction unit configured to: in a case where a color difference between the third color and the fourth color is less than a predetermined threshold, in a case where the first color is not included in the particular color information, correct a conversion parameter in the color conversion processing such that a color obtained by converting the first color is a fifth color whose color difference from the fourth color is greater than the color difference between the third color and the fourth color and which is defined in the second color gamut, and in a case where the first color is included in the particular color information, correct a conversion parameter in the color conversion processing such that a color obtained by converting the second color is a sixth color whose color difference from the third color is greater than the color difference between the third color and the fourth color and which is defined in the second color gamut.

According to another embodiment of the present disclosure, an information processing method includes obtaining first color information from an image that includes a pixel representing color information of a first color defined in a first color gamut and a pixel representing color information of a second color defined in the first color gamut; setting second color information indicating particular color information; executing, on the image, color conversion processing for converting the first color into a third color defined in a second color gamut and converting the second color into a fourth color defined in the second color gamut; and in a case where a color difference between the third color and the fourth color is less than a predetermined threshold, in a case where the first color is not included in the particular color information, correcting a conversion parameter in the color conversion processing such that a color obtained by converting the first color is a fifth color whose color difference from the fourth color is greater than the color difference between the third color and the fourth color and which is defined in the second color gamut, and in a case where the first color is included in the particular color information, correcting a conversion parameter in the color conversion processing such that a color obtained by converting the second color is a sixth color whose color difference from the third color is greater than the color difference between the third color and the fourth color and which is defined in the second color gamut.

According to yet another embodiment of the present disclosure, a non-transitory computer-readable storage medium stores a program which, when executed by a computer including a processor and a memory, causes the computer to obtain first color information from an image that includes a pixel representing color information of a first color defined in a first color gamut and a pixel representing color information of a second color defined in the first color gamut; set second color information indicating particular color information; execute, on the image, color conversion processing for converting the first color into a third color defined in a second color gamut and converting the second color into a fourth color defined in the second color gamut; and in a case where a color difference between the third color and the fourth color is less than a predetermined threshold, in a case where the first color is not included in the particular color information, correct a conversion parameter in the color conversion processing such that a color obtained by converting the first color is a fifth color whose color difference from the fourth color is greater than the color difference between the third color and the fourth color and which is defined in the second color gamut, and in a case where the first color is included in the particular color information, correct a conversion parameter in the color conversion processing such that a color obtained by converting the second color is a sixth color whose color difference from the third color is greater than the color difference between the third color and the fourth color and which is defined in the second color gamut.

Further features of the present disclosure will become apparent from the following description of exemplary embodiments (with reference to the attached drawings).

### BRIEF DESCRIPTION OF THE DRAWINGS

FIG. 1 is a block diagram illustrating an example of a configuration of a system including an information processing apparatus.

FIG. 2 is a flowchart for explaining an example of the overall processing according to a first embodiment.

FIG. 3 is a flowchart for explaining an example of processing for creating a degradation-corrected table according to the first embodiment.

FIG. 4 is a diagram schematically illustrating color degradation correction processing according to the first embodiment.

FIG. 5 is a diagram for explaining blocking for each hue according to a second embodiment.

FIG. 6 is a diagram for explaining processing for correcting color degradation in a lightness direction according to the second embodiment.

FIG. 7 is a diagram for explaining a lightness conversion table according to the second embodiment.

FIG. 8 is a diagram for explaining color degradation correction according to a third embodiment.

FIG. 9 is a flowchart for explaining an example of the overall processing according to a fourth embodiment.

FIG. 10 is a diagram for explaining original data according to a fourth embodiment.

FIG. 11 is a flowchart for explaining an example of partial area setting processing according to the fourth embodiment.

FIG. 12 is a diagram for explaining unit tiles in the original data according to the fourth embodiment.

FIG. 13 is a diagram illustrating partial areas set by the setting processing according to the fourth embodiment.

FIG. 14 is a diagram for explaining a configuration of an image forming apparatus.

FIG. 15 is a diagram for explaining a UI for selection by a user.

FIG. 16 is a diagram illustrating an example of a UI for setting absolute colors.

FIG. 17 is a diagram illustrating an example of a UI for setting absolute colors.

FIG. 18 is a diagram illustrating an example of a UI for setting a color correction method.

FIG. 19 is a diagram for explaining processing for correcting color degradation in a lightness direction for when an absolute color is included.

FIG. 20 is a diagram for explaining a lightness conversion table for when an absolute color is included.

### DESCRIPTION OF THE EMBODIMENTS

Hereinafter, various exemplary embodiments features, and aspects will be described in detail with reference to the attached drawings. Note, the following embodiments are not intended to limit the scope of the claimed invention. Multiple features are described in the embodiments, but limitation is not made to embodiments that use all such features, and multiple such features may be combined as appropriate. Furthermore, in the attached drawings, the same reference numerals are given to the same or similar configurations, and redundant description thereof is omitted.

When “perceptual” mapping described in Japanese Patent Laid-Open No. 2020-27948 is performed, even if a color in the color space of a digital original can be reproduced by a printer, chroma may be reduced. In addition, when “absolute colorimetric” mapping is performed, color degradation may occur among a plurality of colors included in a digital original that are outside the reproduction color gamut of a printer due to the mapping. Further, in Japanese Patent Laid-Open No. H07-203234, since inputted color image signals are uniquely compressed in a chroma direction, there are still concerns about the effect of reducing the extent of color degradation.

The embodiments of the present disclosure provide an information processing apparatus capable of mapping colors to a print color gamut so as to reduce the extent of color conversion caused by color conversion and performing preservation for a color for which it is desired to retain absolute color appearance in color mapping.

### First Embodiment

The terms to be used in the specification will be defined in advance as follows.

### [Color Reproduction Gamut]

A color reproduction gamut according to the present embodiment refers to a range of colors that can be reproduced in an arbitrary color space. In the following, the color reproduction gamut will also be referred to as a color reproduction range, a color gamut, or a gamut. As an index for expressing the size of the color reproduction gamut, there is color gamut volume. The color gamut volume is a three-dimensional volume in an arbitrary color space.

Cases where chromaticity points constituting a color reproduction gamut are discrete are conceivable. For example, cases where a particular color reproduction gamut is represented using 729 points on CIE-L*a*b* and points therebetween are obtained using a known interpolation operation, such as tetrahedral interpolation or cubic interpolation, are conceivable. In such cases, a sum of calculated volumes (on CIE-L*a*b*) of tetrahedrons, cubes, or the like constituting the color reproduction gamut and corresponding to the interpolation calculation method can be used for a corresponding color gamut volume.

The color reproduction gamut and the color gamut according to the present embodiment will be described using an example in which the color reproduction gamut within the CIE-L*a*b* space is used but are not particularly limited thereto so long as similar processing can be performed, and a different color reproduction gamut may be used. Similarly, a numerical value of the color reproduction gamut according to the present embodiment indicates a volume for when cumulative calculation is performed in the CIE-L*a*b* space based on tetrahedral interpolation but is not particularly limited thereto.

### [Gamut Mapping]

Gamut mapping according to the present embodiment is processing for converting a color in a given color gamut into a color in a different color gamut. For example, mapping a color in an input color gamut to an output color gamut is referred to as gamut mapping, and conversion within the same color gamut is not referred to as gamut mapping. International Color Consortium (ICC) profile maps, such as perceptual, saturation, and colorimetric, may be used in gamut mapping. In the following, assume that mapping processing in gamut mapping is referred to when “mapping processing” simply indicated.

In the mapping processing, conversion may be performed using a single 3D lookup table (LUT). The mapping processing may also be performed after color space conversion into a standard color space. For example, a configuration may be taken such that when an input color space is standard red, green, blue (sRGB), the inputted colors are converted into colors in the CIE-L*a*b* color space and processing for mapping to an output color gamut is performed in the CIE-L*a*b* color space. The mapping processing may be 3D LUT processing and may be processing in which a conversion formula is used. Further, the mapping processing and the processing for conversion from a color space at the time of input to a color space at the time of output may be performed simultaneously. For example, a configuration may be taken such that at the time of input, the color space is sRGB, and at the time of output, conversion into RGB values or CMYK values unique to an image forming apparatus is performed.

### [Original Data]

Assume that original data according to the present embodiment is the entire input digital data to be processed and is constituted by one or more pages. A single page of original data may be held as image data or represented by a drawing command. A configuration may be taken such that when represented by a drawing command, the original data is rendered and, after being converted into image data, is processed. The image data is constituted by a plurality of pixels arranged two-dimensionally. The pixels hold information representing a color in the color space. The information representing a color may include an RGB value, a CMYK value, a K value, a CIE-L*a*b* value, an HSV (hue, saturation, value) value, an HLS (hue, lightness, saturation) value, or the like.

### [Color Difference Reduction, Color Degradation]

In the present embodiment, a post-mapping distance between colors in a predetermined color space becoming smaller than a pre-mapping distance between colors when gamut mapping is performed for any two colors will simply be referred to as “color difference reduction”. When color difference reduction occurs, it is conceivable that what had been recognized to be different colors before mapping will be recognized to be the same color after mapping due to the post-mapping color difference being reduced. Assume that in the following, cases where color difference reduction occurs and the post-conversion color difference becomes less than a predetermined threshold will be referred to as “color degradation”. The threshold to be used here will be described later.

Color degradation will be described below using a specific example. Here, it is assumed that there are a color A and a color B in a digital original, and by being mapped to a color gamut of a printer, the color A has been converted to a color C and the color B has been converted to a color D. Here, a case where a distance between the color C and the color D is smaller than a distance between the color A and the color B and a color difference between the color C and the color D is less than a predetermined threshold is a state defined as color degradation. When color degradation occurs, colors that had been recognized to be different colors in a digital original will be recognized to be the same color when printed. For example, when printing a graph in which different items are recognized by the use of different colors, if the different colors end up being recognized to be the same color due to color degradation, there is a possibility that items may be misrecognized to be the same item despite being different.

In the present embodiment, an arbitrary color space may be used as a predetermined color space for calculating a distance between colors. For example, the sRGB color space, an Adobe RGB color space, the CIE-L*a*b* color space, a CIE-LUV color space, an XYZ color system color space, an xyY color system color space, an HSV color space, an HLS color space, or the like may be used when calculating a color difference.

### [Information Processing Apparatus]

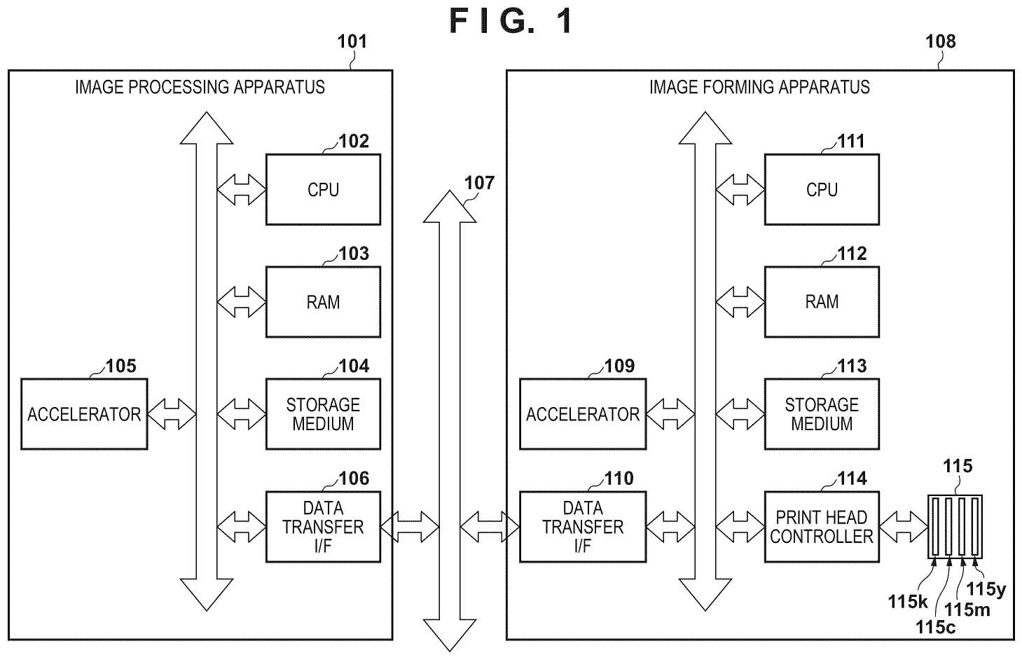

FIG. 1 is a block diagram illustrating an example of a configuration of an information processing apparatus and an image forming apparatus according to the present embodiment. In the present embodiment, a personal computer (PC), a tablet, a server, or an image forming apparatus can be used as an information processing apparatus 101. The information processing apparatus 101 includes a central processing unit (CPU) 102, a random-access memory (RAM) 103, a storage medium 104, an accelerator 105, and a transfer interface (I/F) 106, and can include other components.

The CPU 102 may include one or more processors and executes various processes by reading out a program stored in the storage medium 104, such as an hard disk drive (HDD) or a read only memory (ROM), to the RAM 103, which serves as a work area, and executing the program. For example, the CPU 102 obtains a command based on user input obtained via a Human Interface Device (HID) I/F (not illustrated). The CPU 102 executes various processes according to the obtained command or a program stored in the storage medium 104. The CPU 102 performs predetermined processing according to a program stored in the storage medium 104 on original data obtained through the transfer I/F 106. Then, the CPU 102 displays a result of such processing and various kinds of information on a display (not illustrated) and transmits them to an external apparatus via the transfer I/F 106.

The accelerator 105 is hardware capable of performing information processing faster than the CPU 102. The accelerator 105 is activated by the CPU 102 writing parameters and data used for information processing to a predetermined address of the RAM 103. The accelerator 105 reads the above parameters and data and then performs information processing on the data. The accelerator 105 according to the present embodiment is not an essential element, and equivalent processing may be performed in the CPU 102. The accelerator is specifically a GPU or a specially designed electric circuit. The above parameters may be stored in the storage medium 104 or may be obtained externally via the transfer I/F 106.

An image forming apparatus 108 is an apparatus that forms an image on a print medium. The image forming apparatus 108 according to the present embodiment includes an accelerator 109, a transfer I/F 110, a CPU 111, a RAM 112, a storage medium 113, a print head controller 114, and a print head 115.

The CPU 111 is a central processing unit and comprehensively controls the image forming apparatus 108 by reading out a program stored in the storage medium 113 to the RAM 112, which serves as a work area, and executing the program. The accelerator 109 is hardware capable of performing information processing faster than the CPU 111. The accelerator 109 is activated by the CPU 111 writing parameters and data used for information processing to a predetermined address of the RAM 112. The accelerator 109 reads the above parameters and data and then performs information processing on the data. The accelerator 109 according to the present embodiment is not an essential element, and equivalent processing may be performed in the CPU 111. The above parameters may be stored in the storage medium 113 or may be stored in a storage (not illustrated), such as a flash memory or an HDD.

Here, information processing to be performed by the CPU 111 or the accelerator 109 will be described. The information processing to be performed by the CPU 111 or the accelerator 109 according to the present embodiment is, for example, processing for generating, based on obtained print data, data indicating positions at which ink dots are to be formed in each scan by the print head 115.

In the present embodiment, description will be given assuming that the information processing apparatus 101 performs respective processes, which include color conversion processing and quantization processing to be described below, and based on print data generated by those processes, the image forming apparatus 108 performs image forming processing. However, if similar functions can be implemented, the processes to be performed by the information processing apparatus 101 and the image forming apparatus 108 are not particularly limited thereto, and some or all of the processes described as being performed by the information processing apparatus 101 may be executed by the image forming apparatus 108. For example, the image forming apparatus 108 may perform the color conversion processing and the quantization processing.

The information processing apparatus 101 according to the present embodiment converts a color represented in a first color gamut included in inputted image data into a color represented in a second color gamut. In the following, it is assumed that such processing for converting a color between color gamuts performed by the information processing apparatus 101 is referred to when “color conversion processing” is simply indicated. In the present embodiment, inputted image data is converted into data (ink data) indicating a color and a density of ink for each pixel to be printed by the image forming apparatus 108 by color conversion processing performed by the information processing apparatus 101.

For example, obtained print data includes image data representing an image. When the image data is data representing an image in color space coordinates (here, standard red, green, blue (sRGB)) that are a color representation for a monitor, the data representing an image in those color coordinates (R, G, and B) is converted into ink data (here, CMYK), which is handled by the image forming apparatus 108, by color conversion processing. A color conversion method according to the present embodiment is realized by known conversion processing, such as matrix calculation processing or processing in which a three-dimensional LUT or a four-dimensional LUT is used.

The image forming apparatus 108 according to the present embodiment uses black (K), cyan (C), magenta (M), and yellow (Y) inks as an example. Therefore, RGB signal image data is converted into image data constituting of K, C, M, and Y color signals, each with 8 bits. The color signal of each color corresponds to an application amount of each ink. Further, although the number of ink colors to be used will be described using a case where there are four colors, K, C, M, and Y, as an example, another ink colors, such as light cyan (Lc), light magenta (Lm), or gray (Gy) ink, which is low in density, may be used for the purpose of improving image quality, for example. In that case, an ink signal corresponding to that color is generated.

The information processing apparatus 101 performs quantization processing on the ink data after the color conversion processing. The quantization processing according to the present embodiment is processing for reducing the number of levels of tones of the ink data. The information processing apparatus 101 according to the present embodiment performs quantization for each pixel using a dither matrix in which thresholds with which the values of the ink data to be compared are arranged. After the quantization processing, finally, binary data indicating whether to form a dot at a respective dot formation position is generated.

After the binary data to be used for printing is generated, the print head controller 114 transfers the binary data to the print head 115. At the same time, the CPU 111 performs print control so as to operate a carriage motor, which operates the print head 115 via the print head controller 114, and to further operate a conveyance motor, which conveys a print medium. The print head 115 forms an image by scanning over the print medium and, at the same time, discharging ink droplets onto the print medium.

The information processing apparatus 101 and the image forming apparatus 108 are connected via a communication line 107. In the present embodiment, it is assumed that a local area network is used as the communication line 107; however, the information processing apparatus 101 and the image forming apparatus 108 are not particularly limited thereto so long as they can be connected so as to be capable of communication. The communication line 107 may be, for example, a universal serial bus (USB) hub, a wireless communication network in which a wireless access point is used, a connection in which a Wi-Fi Direct® communication function is used, or the like.

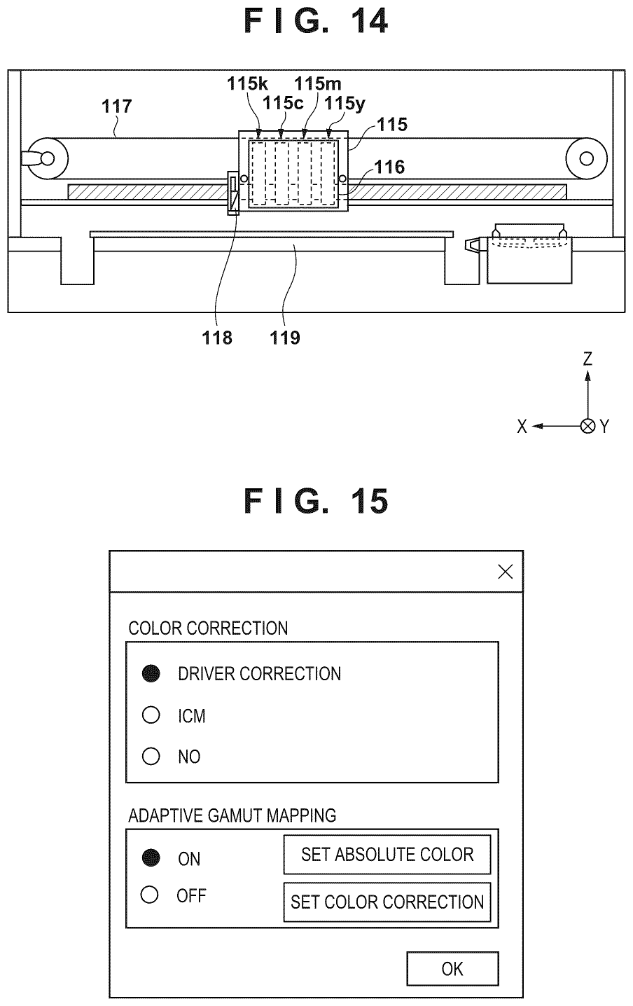

The print head 115 will be described below as having print nozzle arrays for four colors of color ink, which are cyan (C), magenta (M), yellow (Y), and black (K). FIG. 14 is a diagram for explaining the print head 115 according to the present embodiment. In the image forming processing according to the present embodiment, an image is formed by a plurality of (N) scans on a unit area proportional to one nozzle array.

The print head 115 includes a carriage 116, nozzle arrays 115k, 115c, 115m, and 115y, and an optical sensor 118. The carriage 116 on which the four nozzle arrays 115k, 115c, 115m, and 115y and the optical sensor 118 are mounted can be reciprocated along an X direction (main scanning direction) in the figure by the driving force of the carriage motor transmitted through a belt 117. As the carriage 116 moves in the X direction relative to a print medium, an ink droplet is discharged from each nozzle in the nozzle arrays in a gravitational direction (−Z direction in the figure) based on print data. With this, an image proportional to 1/N-th of a main scan is formed on the print medium mounted on a platen 119. When one main scan is completed, the print medium is conveyed along a conveyance direction (−Y direction in the figure), which intersects the main scanning direction, by a distance corresponding to a width of 1/N-th of a main scan. With these operations, an image that is a width of one nozzle array is formed by a plurality of (N) scans. By alternately repeating such a main scan and a conveyance operation, an image is gradually formed on the print medium. By doing so, it is possible to perform control so as to complete image formation for a predetermined area.

When performing printing, there are cases where a color for which it is desired to retain an absolute color appearance is included in a print target. For example, when printing a color that reminds one of a company, such as a corporate color, an absolute color appearance of that color is important; therefore, it is conceivable to create print data so as to retain such a color as much as possible.

From such a viewpoint, when an inputted image includes a particular color (absolute color) for which it is set that such absolute color appearance is important, the information processing apparatus 101 according to the present embodiment can correct a conversion parameter for color conversion processing when performing color conversion processing according to gamut mapping such that a post-conversion color of such an absolute color is not changed.

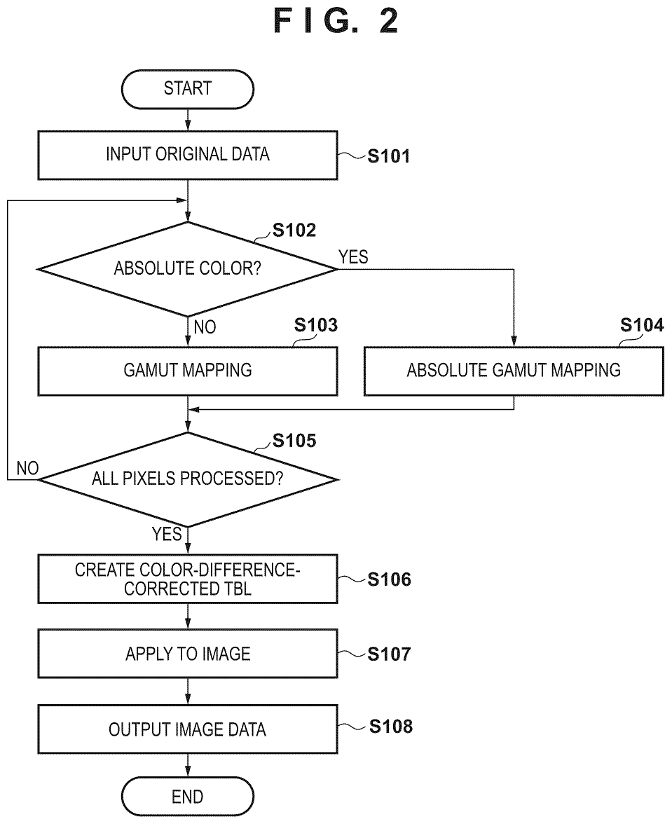

FIG. 2 is a flowchart for explaining an example of the overall processing to be performed by the information processing apparatus 101 according to the present embodiment. The information processing apparatus 101 according to the present embodiment can reduce the extent of color degradation by increasing a distance between colors in a color space after color conversion for a combination of colors in which color degradation occurs due to color conversion processing. In particular, when the first color includes the above absolute color, the information processing apparatus 101 according to the present embodiment reduces the extent of color degradation for the first color and the second color in which color degeneration occurs due to color conversion processing by increasing the distance between the colors in the color space after color conversion such that the post-conversion color of the first color does not change and the post-conversion color of the second color changes. The processing of FIG. 2 is realized, for example, by the CPU 102 reading out to the RAM 103 a program stored in the storage medium 104 and executing the program. The processing of FIG. 2 may be performed by the accelerator 105. It is assumed that the processing of FIG. 2 is executed in response to input of image data.

In step S101, the CPU 102 obtains original data to be used for printing. In the present embodiment, it is assumed that the original data stored in the storage medium 104 is obtained; however, the original data may be inputted from an external apparatus through the transfer I/F 106. Next, the CPU 102 obtains image data including color information from the obtained original data. The CPU 102 according to the present embodiment obtains values representing colors represented in a predetermined color space included in the image data. For example, sRGB data, Adobe RGB data, CIE-L*a*b* data, CIE-LUV data, XYZ color system data, xyY color system data, HSV data, or HLS data are used as the values representing colors.

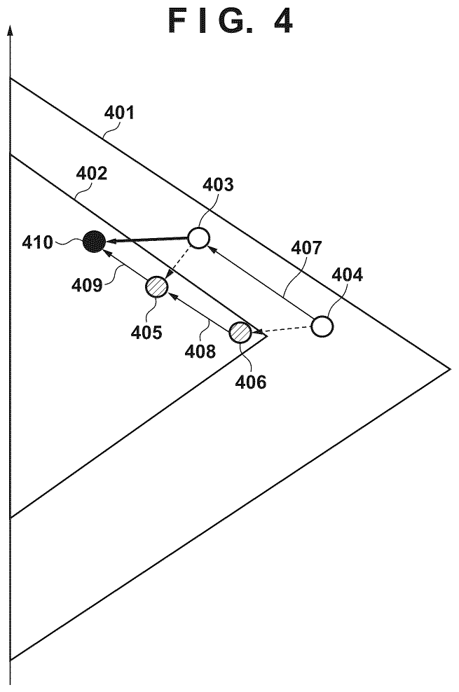

Regarding the original data used here, an image that includes a pixel including color information of a first color and a pixel including color information of a second color is obtained as the original data, and color information of such an image is obtained. In the following, such a first color and a second color are used in each process as unique colors (here, a color 403 and a color 404), which will be described later with reference to FIG. 4 and the like, but the colors to be used in the processes are not limited to these two, and three or more colors may be used.

In step S102, the CPU 102 sets, as a processing target, one of the pixels in the original data obtained in step S101 that have yet to be set as a processing target, and determines whether a color of that pixel is included in the predetermined color information (is a predetermined color). If it is included, the processing proceeds to step S104; otherwise, the processing proceeds to step S103.

In step S103, the CPU 102 performs color conversion on the processing target pixel using a conversion parameter stored in advance in the storage medium 104, sets a value after that color conversion as a post-gamut-mapping value of the processing target pixel, and advances the processing to step S105. The conversion parameter according to the present embodiment is a gamut mapping table, and gamut mapping in which the gamut mapping table is used is performed for the color information of each pixel of the image data as color conversion processing. The gamut-mapped image data is stored in the RAM 103 or the storage medium 104.

The CPU 102 according to the present embodiment uses a three-dimensional look-up table as the gamut mapping table. The CPU 102 references the gamut mapping table and can thereby calculate a combination of output pixel values (Rout, Gout, Bout) obtained by performing gamut mapping on a combination of input pixel values (Rin, Gin, Bin). When Rin, Gin, and Bin, which are input values, each have 256 tones, Table 1 [3], which is a table that has a total of 16,777,216 (=256×256×256) combinations of output values can be used as the gamut mapping table. The color conversion processing may be realized by, for example, performing the processes indicated in the following Equations (1) to (3) for RGB pixel values of the pixel set as the processing target in step S102.

Rout=Table 1[Rin][Gin][Bin][0] (1)

Gout=Table 1[Rin][Gin][Bin][1] (2)

Bout=Table 1[Rin][Gin][Bin][2] (3)

The number of grids of the gamut mapping table is not limited to 256 grids. For example, the number of grids may be reduced from 256 grids (e.g., to 16 grids) so as to determine output values by performing interpolation from table values of a plurality of grids. Known processing to be performed when using a LUT table, such as reducing the table size as described above, may be additionally executed as appropriate.

In step S104, the CPU 102 performs color conversion on the processing target pixel according to absolute gamut mapping, sets a value after that color conversion as a post-gamut-mapping value of the processing target pixel, and advances the processing to step S105. The absolute gamut mapping according to the present embodiment, which is a form of gamut mapping in which the predetermined color information is retained as much as possible. Here, the absolute gamut mapping according to the present embodiment is processing in which, regarding output, a portion that can be matched colorimetrically with a color represented by an sRGB pixel value of an input color is matched therewith, and a pixel value outside the print color gamut that cannot be matched colorimetrically are mapped to the closest color in the print color gamut. A concrete configuration and processing method of a table for an absolute gamut mapping table are the same as those of the example of the gamut mapping table described in step S103, and differences therebetween are the table values. When the processing of step S104 is completed, the processing proceeds to step S105.

In step S105, the CPU 102 determines whether all the pixels of the image have been set as a processing target in step S102. If all of the pixels have been set as a processing target, the processing proceeds to step S106; otherwise, the processing proceeds to step S102.

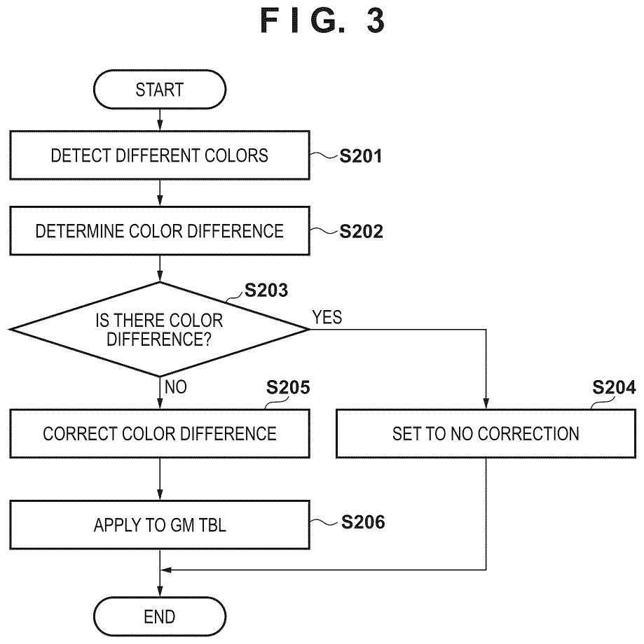

In step S106, the CPU 102 creates a color-degradation-corrected table based on the image data inputted in step S101 and the post-gamut-mapping values of the respective pixels that have been set in steps S103 and S104. The format of the color-degradation-corrected table is similar to the format of the gamut mapping table. The processing performed in step S106 and the color-degradation-corrected table will be described later with reference to FIGS. 3 and 4.

In step S107, the CPU 102 generates color-degradation-corrected image data in which color degradation has been corrected, using the color-degradation-corrected table created in step S106, with image data inputted in step S101 as input. The generated color-degradation-corrected image data is stored in the RAM 103 or the storage medium 104. When step S107 is completed, the processing proceeds to step S108.

In step S108, the CPU 102 outputs the color-degradation-corrected image data stored in step S107 from the information processing apparatus 101 through the transfer I/F 106 and terminates the processing of FIG. 2. The color conversion processing in gamut mapping and absolute gamut mapping may be mapping from a color in the sRGB color space to a color in the color reproduction gamut for printing by the image forming apparatus 108. With such processing, it is possible to reduce a decrease in chroma and color difference caused by performing gamut mapping to what is within the color reproduction gamut of the image forming apparatus 108. In addition, in gamut mapping, parameter selection in which tone reproduction is prioritized may be performed.

The color-degradation-corrected table created in step S106 will be described below with reference to FIG. 3. FIG. 3 is a flowchart for explaining an example of processing for creating the color-degradation-corrected table in step S106. The processing of FIG. 3 is realized, for example, by the CPU 102 reading out to the RAM 103 a program stored in the storage medium 104 and executing the program. The processing of FIG. 3 may be performed by the accelerator 105.

In step S201, the CPU 102 detects all the unique colors included in the image data inputted in step S101. Here, it is assumed that a unique color refers to a color detected in the image data, and each with a different pixel value is detected as a different unique color. Here, results of detection of a unique color are stored in the RAM 103 or the storage medium 104 as a unique color list. Although it is assumed that a unique color is designated using components, such as RGB, one unique color may have a range for each RGB component, and the contents of a unique color may vary depending on the color detection method. The unique color list is initialized at the start of step S201. The CPU 102 repeats the processing for detecting a unique color for each pixel of the image data and determines, for all the pixels included in the image data, whether the color of each pixel is a color that is different from the unique colors that have been detected thus far. The colors that have been determined to be unique colors by such processing are stored as unique colors in the unique color list.

When the input image data is sRGB data, each component has 256 tones; therefore, there are unique colors from a total of 16, 777, 216 (=256×256×256) colors. When all of these colors are detected as unique colors and stored in the unique color list, the number of colors becomes enormous and processing speed decreases. From such a viewpoint, the CPU 102 may discretely detect unique colors. For example, the CPU 102 may reduce colors from 256 tones to 16 tones and then detect a unique color. In such a case, the CPU 102 may group each set of 16 neighboring colors and thereby set 256 tones of colors into 16 tones. With such color reduction processing, it is possible to detect unique colors from a total of 4096 (=16×16×16) colors, thereby increasing the processing speed.

In step S202, the CPU 102 detects a combination of colors in which color degradation occurs among the combinations of unique colors included in the image data based on the unique color list detected in step S201. The processing performed in step S202 will be described with reference to a schematic diagram of FIG. 4. In FIG. 4, a color gamut of the input image data before being subjected to color conversion processing is indicated as a color gamut 401, and a color gamut after being converted by gamut mapping is indicated as a color gamut 402 on a plane that uses two axes, an L* axis and a C* axis, in the CIE-L*a*b* color space. The input image data includes the color 403 (first color) and the color 404 (second color), which are illustrated in the color gamut 401. A color 405 and a color 406 are colors in the color gamut 402. The color 405 is a color for when gamut mapping has been performed on the color 403, and the color 406 is a color for when gamut mapping has been performed on the color 404.

The CPU 102 according to the present embodiment determines that color degradation occurs when a color difference 408 between the color 405 and the color 406 is smaller than a predetermined threshold. Here, it is assumed that is determined color degradation has occurred when the color difference 408 is smaller than a color difference 407 between the color 403 and the color 404 in addition to the color difference 408 between the color 405 and the color 406 being smaller than the predetermined threshold. The threshold used here can be arbitrarily set according to a user-desired condition. The threshold may be a fixed value or may be a value that varies depending on the combination of colors. For example, the CPU 102 may use the pre-conversion color difference between the combination of colors (here, the color difference 407 between the color 403 and the color 404) as the above predetermined threshold. The CPU 102 repeats such determination processing for all the combinations of colors in the unique color list.

In the present embodiment, a color difference between two colors is calculated as a Euclidean distance in a color space. Since the CIE-L*a*b* color space is a visually uniform color space, the Euclidean distance can be approximated to an amount of change in color. Therefore, humans tend to perceive that colors are close when the Euclidean distance in the CIE-L*a*b* color space decreases and perceive that colors are apart when the Euclidean distance increases. A case where the Euclidean distance (hereinafter, referred to as a color difference ΔE) in the CIE-L*a*b* color space is used as a color difference will be described below. The color information in the CIE-L*a*b* color space is represented using a color space with three axes, L*, a*, and b*. The color 403 is represented using L403, a403, and b403. The color 404 is represented using L404, a404, and b404. The color 405 is represented using LA05, a405, and b405. The color 406 is represented using L406, a406, and b406. When the input image data is represented by another color space, the input image data may be converted to the CIE-L*a*b* color space by a known color space conversion technique, and subsequent processing may be performed as is in that color space. The equations for calculating the color difference ΔE 407 and the color difference ΔE 408 are as follows.

$${E}_{407} = \sqrt{{( {L}_{403} - {L}_{404} )}^{2} + {( {a}_{403} - {a}_{404} )}^{2} + {( {b}_{403} - {b}_{404} )}^{2}} \qquad ( 4 )$$

$$Δ {E}_{408} = \sqrt{{( {L}_{405} - {L}_{406} )}^{2} + {( {a}_{405} - {a}_{406} )}^{2} + {( {b}_{405} - {b}_{406} )}^{2}} \qquad ( 5 )$$

The CPU 102 determines that color degradation occurs when the color difference ΔE 408 is smaller than the threshold. If the post-conversion color difference ΔE 408 is to an extent to which colors can be distinguished to be different based on human color difference identification, it is possible to determine that color degradation has not occurred and the color difference does not need to be corrected. From such a viewpoint, the threshold used here may be, for example, 2.0. As described above, the threshold may be the same value as ΔE 407. The CPU 102 may determine that color degradation occurs when the color difference ΔE 408 is smaller than 2.0 and when the color difference ΔE 408 is smaller than the color difference ΔΕ 407.

In step S203, the CPU 102 determines whether the number of combinations of colors for which it has been determined in step S202 that color degradation occurs is zero. If it is zero, the processing proceeds to step S204, and otherwise, the processing proceeds to step S205; in step S204, the CPU 102 determines that the input image data is an image that does not need color degradation correction and ends the processing of FIG. 2.

Although description has been given assuming that an image is determined to not need color degradation correction when the number of colors for which it is determined that color degradation occurs is zero, processing is not particularly limited thereto. For example, the CPU 102 may determine whether an image does not need color degradation correction based on the number of combinations of colors in which color degradation occurs relative to the total number of combinations of unique colors. In that case, the CPU 102 may determine that an image needs color degradation correction if the number of combinations of colors in which color degradation occurs is a majority of the total number of combinations of unique colors, for example. With such processing, it is possible to perform setting so as to execute color degradation correction only when it can be determined that color degradation correction is more desirable.

In step S205, the CPU 102 performs color degradation correction for a combination of colors in which color degradation occurs, based on the input image data and the degradation-corrected table.

FIG. 4 illustrates a case where neither the color 403 nor the color 404 is an absolute color; therefore, the post-conversion colors 405, 406, and 410 all are different colors from the pre-conversion colors. In the present embodiment, assuming that either the color 403 or the color 404 is an absolute color, color conversion processing is performed on the absolute color according to the above absolute gamut mapping, and a post-conversion color of the other color is determined such that color degeneration relative to a post-color conversion of the absolute color is reduced.

The color degradation correction performed by the CPU 102 according to the present embodiment will be described in detail with reference to FIG. 4. First, color degeneration correction performed for when neither the color 403 nor the color 404 is an absolute color will be described. In FIG. 4, it is determined that color degradation occurs in the color combination of the color 403 and the color 404. Therefore, the CPU 102 according to the present embodiment corrects the conversion parameter to be used in the color conversion processing such that a post-color-conversion color difference between the color 403 and the color 404 will be larger. That is, the CPU 102 can correct the conversion parameter so as to increase a post-color-conversion distance between colors in a given color space. With such correction, the extent of color degradation can be reduced. Here, the CPU 102 sets a distance between colors (distance between distinguishable colors) that allows them to be identified as different colors based on characteristics of visual perception of humans and corrects the conversion parameter of the color conversion processing so that a post-conversion color difference between the two colors will assume such a distance between colors.

Here, the CPU 102 sets the above distance between distinguishable colors as the distance between colors whose color difference ΔE is 2.0 or more. The conversion parameter may be corrected such that the post-conversion color difference between two colors is equivalent to the color difference ΔE 407 between the pre-conversion color 403 and color 404.

The processing for correcting color degradation is repeated for all the combinations of colors in which color degradation occurs. The results of color degradation correction proportional to the number of combinations of colors are stored in a table in association with the uncorrected color information and the corrected color information in step S206, which will be described later, and a table in which a corresponding parameter has been thus corrected is set as a color-degradation-corrected table. In the example illustrated in FIG. 4, the color information is represented by color information in the CIE-L*a*b* color space. Therefore, the CPU 102 may convert the color information to be stored in the color-degradation-corrected table to a color in the color space of the input image data and a color in the color space of the output image data and then store the color information. In that case, it is assumed that uncorrected color information is converted into color information in the color space of the input image data, and corrected color information is converted into color information in the color space of the output image data and then stored in the color-degradation-corrected table.

Next, such color degradation correction processing will be described in detail. The CPU 102 obtains a color difference correction amount 409 for the post-conversion color difference ΔE 408 to be the distance between distinguishable colors. In the present embodiment, the distance between distinguishable colors is set to be the color difference ΔE 2.0, and a difference between such a value 2.0 and the color difference ΔE 408 is calculated as the color difference correction amount 409. The CPU 102 may calculate the color difference correction amount 409 as a difference between the color difference ΔE 407 and the color difference ΔE 408.

In FIG. 4, a color obtained by correcting the color 405 by the color difference correction amount 409 on a line extending from the color 406 to the color 405 in the CIE-L*a*b* color space is indicated as a color 410. In the present embodiment, description will be given assuming that the color 410 thus calculated by color conversion processing after color degradation correction is a color that is present on a line extending from the color 406 to the color 405. However, the present disclosure is not particularly limited thereto so long as the color difference between the color 406 and the color 410 is greater than or equal to a sum of the color difference ΔE 408 and the color difference correction amount 409. For example, the color 410 may be a color at a position apart from the color 406 in the CIE-L*a*b* color space by a distance that is proportional to a sum of the color difference ΔE 408 and the color difference correction amount 409 in any of a lightness direction, a chroma direction, and a hue angle direction. The color 410 may be a color that is apart from the color 406 by a sum of the color difference ΔE 408 and the color difference correction amount 409, taking into account not only one direction but also each of the lightness direction, the chroma direction, and the hue angle direction.

In the example of FIG. 4, the color conversion parameter is corrected such that a post-conversion color of the color 403 will be the color 410 instead of the color 405. However, so long as a post-conversion color difference between two colors is the distance between distinguishable colors as described above, a post-conversion color of the color 404 may be a different color from the color 406, or the post-conversion colors of both the color 403 and the color 404 may be different colors from uncorrected colors, for example. In the example of FIG. 4, when an attempt is made to correct the color 406 by the color difference correction amount 409 on a line extending from the color 405 to the color 406 in the CIE-L*a*b* color space, it goes out of the color gamut 402; therefore, such correction cannot be performed. Therefore, when changing the post-conversion color of the color 404 by correcting the conversion parameter, setting is made such that the color will be on a boundary plane of the color gamut 402 and an inter-color distance thereof from the color 405 is the distance between distinguishable colors. Here, if a distance between two post-conversion colors does not reach the distance between distinguishable colors simply by changing the post-conversion color of the color 404, the deficiency to the distance between distinguishable colors may be compensated for by correcting the conversion parameter so as to change the post-conversion color of the color 403.

Next, color degeneration correction performed for when either the color 403 or the color 404 is an absolute color will be described. In the following, description will be given assuming that the color 403 is an absolute color and the color 404 is not an absolute color. Here, similarly to the above example, it is determined that color degeneration occurs in the combination of the color 403 and the color 404; therefore, the conversion parameter to be used in the color conversion processing is corrected so as to increase the post-color-conversion color difference between the color 403 and the color 404.

In the example illustrated in FIG. 4, description has been given assuming that color degeneration correction is performed such that the post-conversion color 405 of the color 403 will be the color 410. Meanwhile, when the color 403 is an absolute color, the CPU 102 according to the present embodiment performs color degeneration correction by changing the post-conversion color of the color 404 without changing the post-conversion color of the color 403 such that the post-conversion color difference between the two colors will be a distance between distinguishable colors. Here, the color 403, which is an absolute color, is converted according to absolute gamut mapping (step S104), and a post-conversion color according to such conversion is maintained without being changed.

The color degeneration correction according to the present embodiment is performed similarly to the above example of FIG. 4 except for not changing a post-conversion color of an absolute color (color 403). Here “not changing a post-conversion color” is not limited to processing in which a color is not changed at all but may also include processing in which a color is changed within a predetermined range set as a range in which a color is recognized to be not changed. For example, a case where a color difference with that after conversion is a predetermined threshold or less (e.g., the color difference ΔE is 0.01 or less) may be set as a range in which a color is recognized to be not changed.

With such processing, it is possible to perform color degeneration correction while maintaining an absolute color for which it is set that absolute color appearance is important. Accordingly, it is possible to reduce color degeneration for colors between which there is sufficient color difference at their input image data state but between which color degeneration occurs after gamut mapping, while maintaining an absolute color (while preventing changes unanticipated by the user) for one of the colors that is an absolute color.

In step S206, the CPU 102 corrects the gamut mapping table by using a result of color degradation correction of step S205 and sets it as the degradation-corrected table. Here, the degradation-corrected table is a table that holds, for colors on which absolute gamut mapping has been performed in step S104, post-conversion colors thereof as they are as output and holds, for other colors, post-color-degeneration-correction colors calculated as results of step S205 as output. That is, the CPU 102 corrects the gamut mapping table such that output for when a color that is not an absolute color is inputted will be a post-color-degeneration-correction color calculated in step S205. The correction of the gamut mapping table is performed repeatedly for all the combinations of colors in which color degradation occurs. With such processing, the degradation-corrected table is created.

With the processing illustrated in FIG. 3, by creating the degradation-corrected table and then converting the input image using such a table, it is possible to increase the distance between colors for a combination of colors in which color degradation occurs after conversion among the combinations of unique colors included in the input image. Therefore, it is possible to reduce the extent of color degradation in the combination of colors in which color degradation occurs due to conversion.

If the input image data is sRGB data, the gamut mapping table is created assuming that the input image data has 16, 777, 216 colors. The gamut mapping table created under this assumption is created taking into account color degradation and chroma for all the colors including those not included in the actual input image data. With the processing described in the present embodiment, by correcting the conversion parameter only for the colors in which color degradation occurs after conversion that have been detected in the input image data, it is possible to create an adaptive degradation-corrected table for the input image data. Therefore, color conversion processing in which the extent of color degradation is reduced can be executed by gamut mapping suitable for the input image data.

In the present embodiment, the processing in a case where the input image data is one page of an image has been described, but the number of pages of the input image data is not particularly limited. When the input image data is a plurality of pages, the flow indicated in FIG. 2 may be performed spanning all the pages or may be performed for each page. With such processing, even when the input image data is a plurality of pages, it is possible to, while maintaining the result of conversion of an absolute color in a similar manner, reduce the extent of color degradation when color degradation occurs.

Further, in the present embodiment, the degradation-corrected table is created by correcting the gamut mapping table; however, the present disclosure is not particularly limited to such processing so long as the post-conversion color difference takes on a similar value. For example, similar conversion may be performed by further performing color conversion according to a different gamut mapping table on image data that has been subject to gamut mapping in which a gamut mapping table that has not been corrected for color degradation has been used as is. In such a case, in step S205, a table for converting color information converted according to uncorrected gamut mapping data into color-degradation-corrected color information is created as a post-gamut-mapping correction table. The post-gamut-mapping correction table generated here is a table for converting the color 405 of FIG. 4, as input, into the color 410. In this case, in step S107, color conversion processing is performed by applying the post-gamut-mapping correction table on the gamut-mapped image data.

In the present embodiment, the processes indicated in FIGS. 2 and 3 are assumed to be started (automatically) in response to accepting input of image data but may be configured so as to be executed based on a user instruction. For example, the CPU 102 may accept user input as to whether to execute each information process according to the present embodiment in a UI screen as illustrated in FIG. 15 to be described below. In the UI screen of FIG. 15, a toggle button for selecting the type of color correction is displayed. Further, in the UI screen of FIG. 15, a toggle button for selecting whether to perform gamut mapping using an adaptive degradation-corrected table by ON and OFF is displayed. With such a configuration, it is possible to switch whether to perform adaptive gamut mapping according to a user instruction. As a result, it is possible to perform adaptive gamut mapping when the user wishes to reduce the extent of color degradation.

A method for setting an absolute color by the CPU 102 according to the present embodiment will be described below with reference to FIGS. 15 to 17. The CPU 102 according to the present embodiment sets an absolute color based on user input. For this, the CPU 102 may accept input of information (e.g., the value of each component of RGB) indicating a color by the user and set the inputted values as an absolute color.

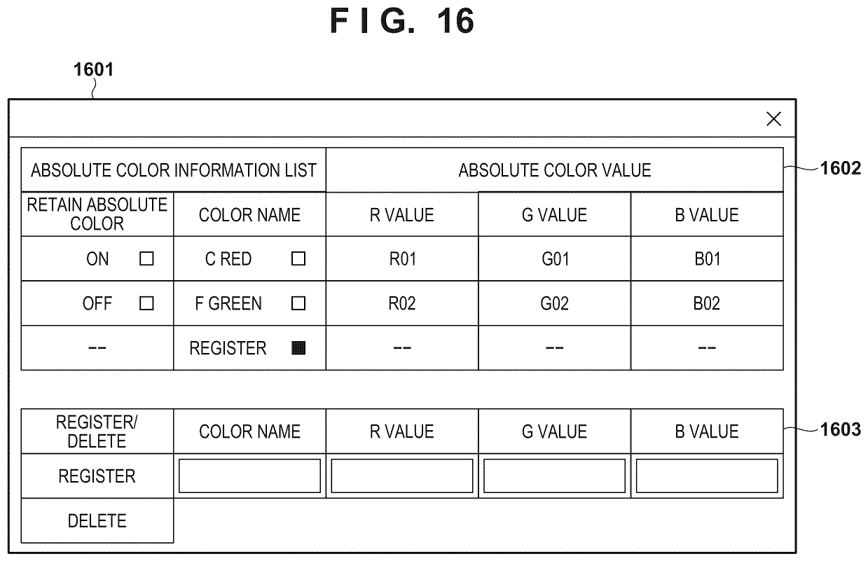

In FIG. 15, a “set an absolute color” button is displayed, and when this button is pressed, it is determined that the user wishes to retain an absolute color appearance of a print target, and a UI for setting an absolute color (here, an absolute color setting dialog 1601 illustrated in FIG. 16) is displayed. A “set color correction” button in FIG. 15 will be described later.

FIG. 16 is a diagram illustrating a dialog for setting an absolute color. The absolute color set here is used in the determination of step S102. In an absolute color setting dialog 1601, an absolute color information list display portion 1602 and a registration and deletion dialog 1603 are displayed.

In the absolute color information list display portion 1602, an absolute color information list for storing information indicating a registered absolute color is displayed. The absolute color information list stores a color name and an absolute color value (R value, G value, and B value) as information indicating an absolute color. In the example illustrated in FIG. 16, two colors, C red (R value=R01, G value=G01, B value=B01) and F green (R value=R01, G value=G01, B value=B01), are registered.

In addition, in the absolute color setting dialog 1601, there is a “retain an absolute color” (ON/OFF) setting for selecting whether to retain the registered absolute color at the time of printing. In the example illustrated in FIG. 16, a setting state is such that C red is retained (ON) and F green is not retained (OFF).

The registration and deletion dialog 1603 is used to set an absolute color. When information indicating a color is inputted to the registration and deletion dialog 1603 by the user and then a register button is pressed, the CPU 102 according to the present embodiment sets the inputted color as an absolute color. In the present embodiment, a “register” button for registering a third color of absolute colors is displayed in a color name item in the absolute color information list display portion 1602, and by the registration button being pressed, the registration and deletion dialog 1603 is displayed. In FIGS. 16 to 18, a black square (▪) indicates a pressed button, and a white square (□) indicates a button that can be pressed but is not pressed.

In the registration and deletion dialog 1603, fields for inputting a color name and an absolute color value (R value, G value, and B value) are displayed. By the user inputting information in this field and pressing a “register” button at the left end, a new absolute color is set. When a “delete” button is pressed here, no new absolute color is set.

The registration and deletion dialog 1603 may be used to change or delete the information of an absolute color that has already been registered. For example, a configuration may be taken such that when a registered absolute color is selected (e.g., when the inside of a color name frame is pressed) in the absolute color information list display portion 1602, the information of a corresponding absolute color is displayed in the registration and deletion dialog 1603. In that case, by the user editing the information displayed in the registration and deletion dialog 1603 and then pressing the “register” button, the information of the absolute color is updated, and by a “delete” button being pressed, the information of the registered absolute color is deleted from the absolute color information list.

Here, description has been given assuming that RGB pixel values of a color are used as information indicating that color. However, the input is not particularly limited thereto so long as a color can be designated. For example, information designating a range of RGB pixel values may be inputted as information indicating a color. For example, a format may be such that the type (name) of a color is inputted as information indicating that color, and RGB values corresponding to that color are read out from the storage medium 104.

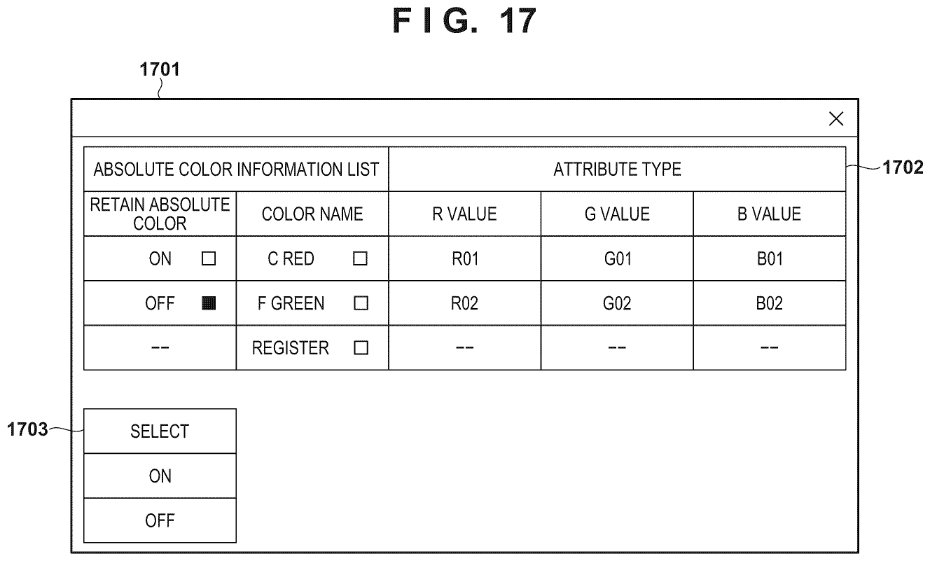

FIG. 17 is a diagram for explaining an example for setting whether to retain an already-registered absolute color at the time of printing. In FIG. 17, an absolute color setting dialog 1701 having similar functions to the absolute color setting dialog 1601 is displayed, and an absolute color information list display portion 1702 having similar functions to the absolute color information list display portion 1602 is displayed in an upper portion.

In FIG. 17, the absolute color setting dialog 1701 displays a selection dialog 1703. The CPU 102 accepts user input as to whether to retain a corresponding absolute color in the selection dialog 1703 and, upon accepting input to retain the absolute color, performs setting so as to retain that absolute color at the time of printing. In the example of FIG. 17, the selection dialog 1703 is displayed in response to a “retain an absolute color” button for F green registered as a second color being pressed, and ON/OFF of “retain an absolute color” is set in response to a selection of ON/OFF in the selection dialog 1703.

With such a configuration, it is possible to, while maintaining the result of conversion of an absolute color in a similar manner, reduce the extent of color degradation when color degradation occurs. Accordingly, it is possible to select color conversion processing according to the user's priority in printing. In particular, when an absolute color is set as illustrated in FIGS. 16 and 17, in step S102 it is determined for each pixel of the original data whether the set absolute color is included, different gamut mapping is performed according to a result of that determination, and color degeneration correction is performed.

In the example of FIGS. 16 and 17, since a color to be retained as an absolute color is only “C red”, in step S102 it is determined whether the color of C red is included in the original data. If setting is performed so as to retain F green as an absolute color in addition to C red, in step S102 it is determined whether the original data includes any of C red and F green. Further, if there is no absolute color set to be retained, the processing proceeds to step S103 regardless of the result of the determination in step S102.

With such a configuration, it is possible to set an absolute color whose absolute color appearance is important and, while maintaining the result of conversion of the set absolute color, reduce the extent of color degradation when color degradation occurs.

### Second Embodiment

[Correction of Repulsive Force within Same Hue]

The information processing apparatus 101 according to the first embodiment detects the number of combinations of colors in which color degradation occurs for all the combinations of unique colors included in the image data and performs color degradation correction processing for each of those. Meanwhile, cases in which it is possible to consider that color degradation has not occurred without even determining whether color degradation has occurred, such as with a combination of colors whose hues are significantly different, are conceivable. Accordingly, the information processing apparatus 101 according to the second embodiment groups a portion corresponding to a hue range among the detected plurality of unique colors as one color group and performs color degradation correction processing within the group. In the following, it is assumed that unique colors thus grouped as one color group is referred to when “group” is simply indicated. Further, in color degeneration correction to be described below, when one of the two colors is an absolute color, it is assumed that color degeneration correction is performed so as to change a post-conversion color of the other color without changing a post-conversion color of the absolute color, similarly to the first embodiment.

The information processing apparatus 101 according to the present embodiment can group detected unique colors by each predetermined hue angle, for example, and perform color degradation correction processing similar to that of the first embodiment within the group. By thus grouping not all the detected unique colors but a portion thereof as a single color group and performing color degradation correction processing only within that portion, the number of combinations to be calculated is reduced, and thereby, the processing load and processing time can be reduced.

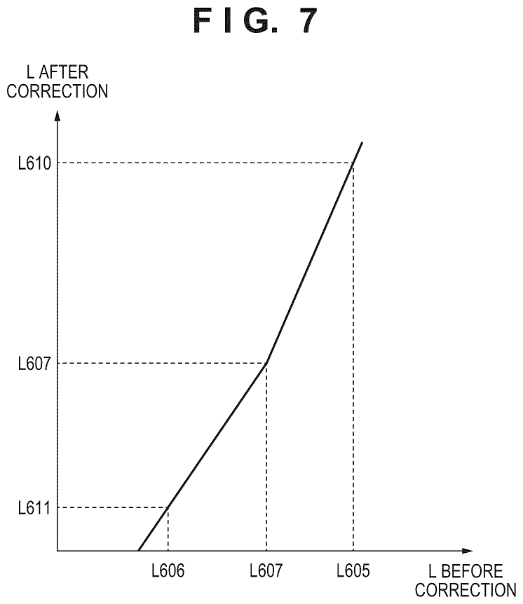

In the present embodiment, when performing color degradation correction, color degradation correction may be performed so that a change in a post-conversion color caused by the color degradation correction occurs only in the lightness direction. By a change in a post-color-conversion color due to the correction of the conversion parameter occurring only in the lightness direction, it is possible to reduce the change in the color appearance caused by the correction of the conversion parameter. In the present embodiment, the conversion parameter may be corrected so that a lightness after conversion according to the color conversion processing after conversion parameter correction is determined based on a lightness of an inputted color and the chroma does not change from that before correction, as in FIG. 7 to be described later, for example.

If a pre-gamut-mapping color difference ΔE is greater than a minimum color difference that can be identified, a color difference ΔE to be retained need only be greater than a minimum color difference ΔE that can be identified. In such a case, it is conceivable to set the conversion parameter such that the post-conversion color difference between two colors approaches the pre-conversion color difference in the color conversion according to gamut mapping. From such a viewpoint, the information processing apparatus 101 according to the present embodiment may correct the conversion parameter so that the post-conversion color is determined based on the post-conversion color and the pre-conversion color difference between colors of the combination. By the post-gamut-mapping color difference between two colors being set to the pre-gamut-mapping color difference by color degradation correction, it is possible to reproduce the pre-gamut-mapping distinguishability even after color conversion. Such a color-degradation-corrected post-gamut-mapping color difference may be greater than a pre-gamut-mapping color difference. In this case, it can be made easier to distinguish between two colors after color conversion than before gamut mapping. Such processing for correcting the conversion parameter will be described below.

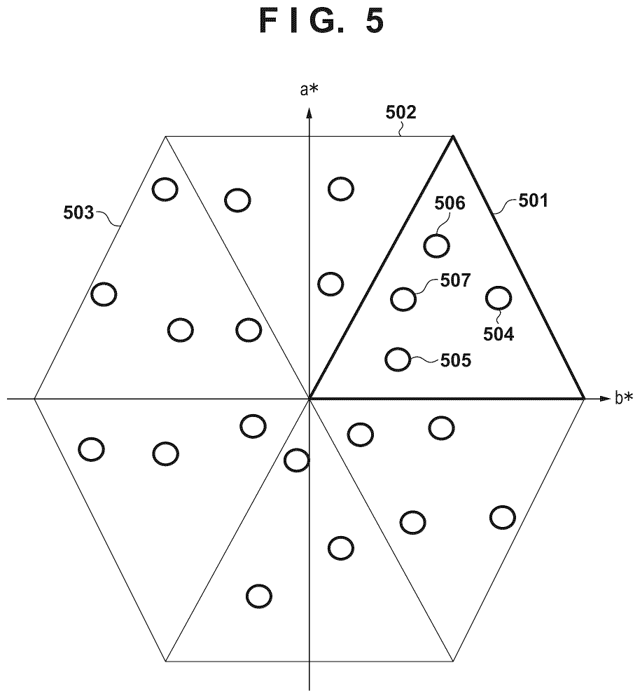

An example of processing for determining whether color degradation occurs, performed in step S202 by the information processing apparatus 101 according to the present embodiment, will be described below with reference to FIG. 5. First, processing to be performed when neither of the colors to be processed is an absolute color will be described. FIG. 5 is a diagram in which two axes, an a* axis and a b* axis, of the CIE-L*a*b* color space are represented in a plane and a plurality of unique colors are plotted. In the present embodiment, as described above, the unique colors within a predetermined hue angle are grouped as one color group. A hue range 501 represents a range in which a plurality of unique colors within a predetermined hue angle are regarded as one color group. In FIG. 5, 360 degrees of hue angle are equally divided into six parts, and the hue range 501 represents a range of 0 degree to 60 degrees. The hue range used for grouping is preferably a hue range that can be recognized as the same color and can be arbitrarily set by the user. For example, in the CIE-L*a*b* color space, a hue range to be grouped as one color group may be set to be a range of 30 degrees to 60 degrees. If the angle is 60 degrees, it can be considered that division and grouping are performed into six color groups of red, green, blue, cyan, magenta, and yellow. If the angle is 30 degrees, the division can be performed according to a color between the colors grouped by 60 degrees.

As illustrated in FIG. 5, a hue range that has been grouped by a fixed angle may be set, or a hue range may be set according to the unique colors included in the image data. For example, a configuration may be taken so as to determine ranges of hue angles, each a range that is set to appear visually uniform (to be the same color), and unique colors are grouped in each of the ranges of hue angles thus set.

Further, in the present embodiment, description will be given assuming that color degradation correction processing is performed using unique colors in one group, which has been grouped using a hue angle; however, the processing for calculating the number of combinations in which color degradation occurs, which will be described below, may be performed using unique colors included in two groups with adjacent hue angle ranges. By thus detecting combinations spanning adjacent hue ranges, it is possible to prevent a steep change in the number of combinations of colors in which color degradation occurs when an area in which to detect the combinations is shifted by one. In this case, if a range that is likely to be recognized as the same color (in the CIE-L*a*b* color space) is 30 degrees, by setting a hue angle range to be formed into one group to 15 degrees, a hue angle for when two hue ranges are combined is 30 degrees. Therefore, it is possible to detect a combination from among hue angle ranges that are likely to be recognized as the same color.

The CPU 102 calculates the number of combinations of colors in which color degradation occurs for the combinations of unique colors within the hue range 501. In FIG. 5, a color 504, a color 505, a color 506, and a color 507 are indicated as colors included in the hue range 501. The CPU 102 according to the present embodiment determines whether color degradation occurs due to color conversion processing for all combinations of the four colors, the color 504, the color 505, the color 506, and the color 507. Such determination processing is repeated in all the hue ranges. With such processing, it is possible to detect a combination of colors in which color degradation occurs for each hue range and calculate the number of such combinations. In FIG. 5, there are a total of six color combinations within the hue range 501. The detection of a combination of colors in which color degradation occurs can be performed similarly to the first embodiment. In the following, it is assumed that, when a combination of colors (two colors) is described, unless specifically mentioned, a combination within one hue range is described.

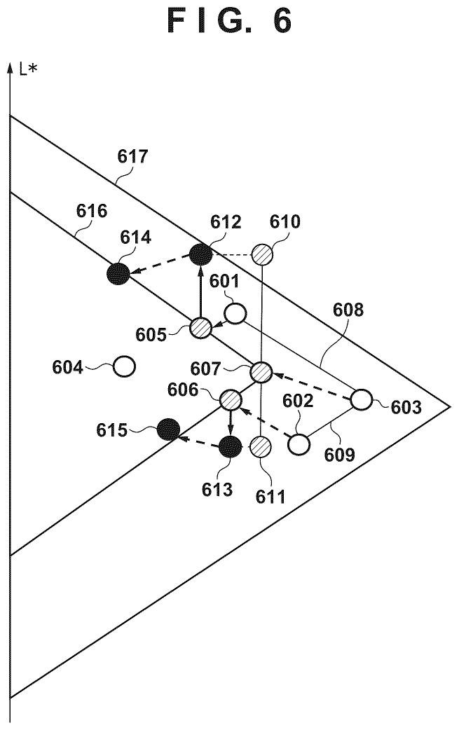

The CPU 102 according to the present embodiment selects a color (reference color) that serves as a reference from among the unique colors included in the grouped color group and, based on a color difference between the reference color and another color, corrects the conversion parameter for the color conversion processing so as to determine the post-conversion color of that other color. The CPU 102 according to the present embodiment can generate, based on the lightness of the reference color and the lightness of a color (hereinafter, referred to as a scale color) different from the reference color, a function (lightness conversion function) for calculating the lightness of a color to be outputted from the lightness of an inputted color in the color conversion processing after conversion parameter correction. In the present embodiment, two scale colors are set for the reference color, one color with higher lightness and one color with lower lightness, and the above lightness conversion function is generated based on the reference color and the two scale colors. The lightness conversion function will be described later as Equation (8). Here, a color 603 (and post-conversion color 607 thereof) is the reference color and a color 601 (and post-conversion color 605 thereof) is the scale color in FIG. 6 to be described later, and a post-conversion color 612 (or a color 614) of the color 601 according to post-degradation-correction gamut mapping is calculated based on the color 605, the color 607, and a color difference between the color 603 and the color 601; such processing will be described later.

An example of the color degradation correction processing performed in step S205 by the information processing apparatus 101 according to the present embodiment will be described below with reference to FIG. 6. In FIG. 6, the color gamut of the input image data before being subjected to the color conversion processing is indicated as a color gamut 617, and the color gamut after being converted by gamut mapping is indicated as a color gamut 616 on a plane that uses two axes, the L* axis and the C* axis, in the CIE-L*a*b* color space. L* represents lightness and C* represents chroma. In addition, the colors 504 to 507 included in the hue range 501 before the color conversion processing is performed are plotted in the color gamut 617 as the colors 601 to 604, respectively. In addition, the colors 605 to 607 are colors in the color gamut 616 after the colors 601 to 603 have been converted by gamut mapping, respectively. Here, a color 604 is assumed to be the same color even after color conversion according to gamut mapping.

The CPU 102 according to the present embodiment can calculate a correction rate, which is a reflection rate of correction of the conversion parameter in color degradation correction, based on a ratio of the number of combinations of colors in which color degradation occurs to the number of combinations of colors included in the group. For example, the CPU 102 according to the present embodiment calculates a correction ratio R for a given group as follows.

R=number of combinations of colors in which color degradation occurs/number of combinations of colors included in the group

The above correction ratio R decreases as a proportion of the combinations of colors in which color degradation occurs within a group decreases, and increases as the proportion increases. For example, in the examples of FIGS. 5 and 6, the number of combinations of colors in the group is six, and when it is determined that color degradation occurs in four of the combinations, the correction ratio R is calculated to be 0.667. By performing correction of the conversion parameter using such a correction ratio, it is possible to increase the level of correction of color degradation as the proportion of the combinations of colors in which color degradation occurs in the group increases.

The CPU 102 according to the present embodiment can set the above reference color from among the unique colors included in the group. In the present embodiment, among the unique colors included in the group, a color (maximum chroma color) with the greatest chroma is set as the reference color. In addition, the CPU 102 sets a color (maximum lightness color) having the greatest lightness and a color (minimum lightness color) having the least lightness as the scale colors for the reference color. In the example of FIG. 6, the color 601 is the maximum lightness color, a color 602 is the minimum lightness color, and the color 603 is the maximum chroma color.

In color degradation correction, the CPU 102 according to the present embodiment generates a corresponding lightness conversion function for each of a unique color (light color group) whose lightness is greater than or equal to the lightness of the maximum chroma color and a unique color (dark color group) whose lightness is less than that of the maximum chroma color. The processing for calculating a correction amount based on the correction ratio R, the maximum lightness color, the minimum lightness color, and the maximum chroma color that is performed by the CPU 102 according to the present embodiment will be described below.

The CPU 102 calculates each of a correction amount Mh for the light color group and a correction amount Ml for the dark color group separately (the use of these correction amounts will be described later in detail). In the following, the color 601, which is the maximum lightness color, is expressed using L601, a601, and b601. Further, the color 602, which is the minimum lightness color, is expressed using L602, a602, and b602. Further, the color 603, which is the maximum chroma color, is expressed using L603, a603, and b603. Here, the CPU 102 may set a value obtained by multiplying the color difference ΔE between the maximum lightness color and the maximum chroma color by the correction ratio R, for example, as the correction amount Mh. Further, the CPU 102 may set a value obtained by multiplying the color difference ΔE between the maximum chroma color and the minimum lightness color by the correction ratio R, for example, as the correction amount Ml. The examples of equations for calculating the correction amount Mh and the correction amount Ml are indicated as Equations (6) and (7) below.

$$Mh = \sqrt{{( {L}_{601} - {L}_{603} )}^{2} + {( {a}_{601} - {a}_{603} )}^{2} + {( {b}_{601} - {b}_{603} )}^{2}} \times R \qquad ( 6 )$$

$$Ml = \sqrt{{( {L}_{602} - {L}_{603} )}^{2} + {( {a}_{602} - {a}_{603} )}^{2} + {( {b}_{602} - {b}_{603} )}^{2}} \times R \qquad ( 7 )$$

In FIG. 6, a color difference between the color 601 and the color 603 is indicated by a color difference ΔE 608, and a color difference between the color 602 and the color 603 is indicated by a color difference ΔE 609. Therefore, the correction amount Mh and the correction amount Ml are values obtained by multiplying each of such color difference ΔE 608 and color difference ΔE 609 by R.

The CPU 102 according to the present embodiment generates a lightness conversion table for each hue range. The lightness conversion table according to the present embodiment is a table that indicates the lightness (post-conversion lightness) of an output pixel according to post-color-degradation-correction gamut mapping for the lightness of an input pixel. A method of creating such a lightness correction table will be described below.

The lightness conversion table according to the present embodiment is a 1D LUT. Such a 1DLUT is smaller in volume compared to a 3D LUT with same the number of items, and it is expected that the processing time used for transfer will be reduced. A post-conversion lightness to be stored in the lightness conversion table is calculated based on the lightness of the reference color, the lightness of the input color, and the lightness of the maximum lightness color (or the minimum lightness color), and the lightness and the correction amount of a color obtained by converting the reference color by gamut mapping (separately for the light color group and the dark color group in the present embodiment). In the following, description will be given assuming that a color to be inputted is a color of the light color group; however, when a color of the dark color group is used, it is possible to perform similar processing using the minimum lightness color instead of the maximum lightness color.

FIG. 7 corresponds to the example of FIG. 6 and is a graph illustrating an example of components of the lightness conversion table according to the present embodiment. In FIG. 7, the lightnesses of input colors in the lightness conversion table are indicated on the horizontal axis, and the lightnesses to be outputted are indicated on the vertical axis. L605 to L611 of FIG. 7 correspond to lightnesses of reference numerals 605 to 611 of FIG. 6. That is, in FIG. 7, the lightnesses, after conversion by gamut mapping, of the maximum lightness color, the reference color, and the minimum lightness color are illustrated as L605, L607, and L606, respectively. In the following, only the lightnesses L607 to L605 of the lightness group range will be described in the graph of FIG. 7.

L610 is a value to be outputted when L605 is inputted to the lightness conversion table and is a value obtained by adding the correction amount Mh to L607. In FIG. 6, a color for which the color 607 has been moved in the lightness direction by the correction amount Mh is indicated as the color 610.

First, the color 610 and a color 612 and the color 614, which are set based on the color 610, will be described. Such a color 610 is a color that has a color difference between the color 603 and the color 601 in a lightness direction as a color difference with the color 607. A color for which the post-conversion color 605 of the color 601 has been moved in the lightness direction so as to have such a lightness L610 is a color 612. By performing color degradation correction so that the post-conversion color of the color 601 is the color 612, the change of the post-color-conversion color is performed only in the lightness direction, and it is possible to reduce the change in color appearance due to correction of the conversion parameter. In addition, in terms of characteristics of visual perception, sensitivity to a lightness difference is high; therefore, by converting a color difference that includes chroma into a lightness difference, it is possible to provide a color that is likely to be perceived as having a larger color difference after conversion even if the lightness difference is small in terms of characteristics of visual perception. In addition, due to the relationship between the sRGB color gamut and the color gamut of an image forming apparatus, a lightness difference is likely to be smaller than a chroma difference. Therefore, by converting a color difference that includes chroma into a lightness difference, it is possible to effectively utilize a narrow color gamut.

Meanwhile, as illustrated in FIG. 7, it is also conceivable that the color 612 thus converted goes out of the color gamut 616. In such a case, a configuration may be taken so as to move the color 612 by color difference minimum mapping to set it to the color 614 in the color gamut 616 and set such the color 614 to be the post-conversion color of the color 601 after color degradation correction. The color difference minimum mapping will be described later with reference to Equations (10) to (14).

In the present embodiment, as illustrated in FIG. 7, an output value for which L607 of the reference color has been inputted to the lightness conversion table is L607 without change. As described above, L610 is an output value for when the lightness L605 of the post-conversion color of the maximum lightness color has been inputted to the lightness conversion table. In the present embodiment, a value for when the lightness of a value greater than L607 and less than L605 is inputted to the lightness conversion table is calculated based on L607 and L610. For example, as illustrated in the graph of FIG. 7, an output value L₂ for when a lightness L₁ greater than L607 and less than L605 is inputted into the lightness conversion table can be calculated by the following Equation (8), which is a lightness conversion function.

$${L}_{2} = L 607 + ( L 610 - L 607 ) \times \frac{{L}_{1} - L 607}{L 605 - L 607} \qquad ( 8 )$$

A table that takes L₁ as input and outputs such a value L₂ is calculated as the lightness conversion table of the light color group. For each color after conversion according to gamut mapping, the lightness thereof is converted using the lightness conversion table, and for a color that may be moved, such as the color 614 for the color 612, a color that has been moved will be the color after conversion according to gamut mapping after color degradation correction in the present embodiment.

Here, a lightness conversion function is assumed to be generated as in Equation (8) based on two points but is not particularly limited thereto so long as output of a corresponding lightness is calculated. For example, the parameters of the lightness conversion function may be calculated from three points assuming that the lightness conversion function is a quadratic function.

In the present embodiment, as described above, L607 of the reference color does not change depending on input to the lightness conversion table. With such processing, by maintaining a post-conversion color for a color with the highest chroma, a color difference can be corrected while maintaining chroma. In addition, an output value for when a lightness that is greater than L605 or a lightness that is less than L606 is inputted to the lightness conversion table is assumed to be undefined here as they are not included in the input image data; however, in such a case, calculation may be performed by applying Equation (8), for example.

Further, when a lightness value that has been outputted by conversion according to the lightness conversion table for the maximum lightness color exceeds the maximum lightness of the color gamut 616 after gamut mapping, the CPU 102 may perform maximum value clipping processing. The maximum value clipping processing according to the present embodiment is processing for subtracting a difference between such an outputted lightness value and the maximum lightness of the color gamut 616 after gamut mapping from the entire output of the lightness conversion table. In this case, the lightness of the maximum chroma color after gamut mapping also changes to the low lightness side. With such processing, even when a unique color included the input image data is skewed to the high lightness side, it is possible to correct the whole so that the lightness tones on the low lightness side are also utilized. Regarding the minimum lightness color, when the minimum lightness after correction is lower than the minimum lightness of the color gamut after gamut mapping, in case where the lightness value outputted in the conversion according to the lightness conversion table exceeds the minimum lightness of the color gamut 616 after gamut mapping, similar processing can be performed.

The CPU 102 according to the present embodiment corrects the gamut mapping table using the values of the lightness conversion table thus calculated, thereby creating a degradation-corrected table for each hue range. Here, the degradation-corrected table is created by correcting the value of the lightness of output of the gamut mapping table to the value of output of the lightness conversion table for each corresponding input.

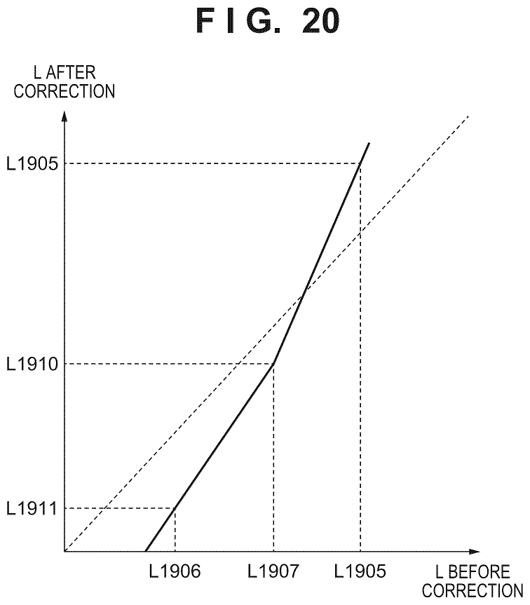

The processing to be performed when neither of the colors to be processed is an absolute color has been described thus far. Next, processing for when an absolute color is included in the colors to be processed will be described with reference to FIG. 19. A color 1902, a color 1903, a color 1904, a color gamut 1916, and a color gamut 1917 of FIG. 16 are identical to the color 602 (minimum lightness color), the color 603 (maximum chroma color), the color 604, the color gamut 616, and the color gamut 617, respectively, of FIG. 6; therefore, duplicate description will be omitted. Further, a color 1901 is the maximum lightness color of FIG. 19 that is included in the hue range 501 as with the color 1902 and the like, and is present in the color gamut 1916. Further, the color 1901 is an absolute color. The correction ratio can be calculated as with that described in FIG. 6.

Here, the CPU 102 can calculate the correction amounts Mh and Ml as in the description for FIG. 6. In the following, the color 1901, which is the maximum lightness color, is expressed using L1901, a1901, and b1901. Further, the color 1902, which is the minimum lightness color, is expressed using L1902, a1902, and b1902. Further, the color 1903, which is the maximum chroma color, is expressed using L1903, a1903, and b1903. The examples of equations for calculating the correction amount Mh and the correction amount Ml are indicated as Equations (6′) and (7′) below.

$$Mh = \sqrt{{( {L}_{1901} - {L}_{1903} )}^{2} + {( {a}_{1901} - {a}_{1903} )}^{2} + {( {b}_{1901} - {b}_{1903} )}^{2}} \times R \qquad ( {6}^{′} )$$

$$Ml = \sqrt{{( {L}_{1902} - {L}_{1903} )}^{2} + {( {a}_{1902} - {a}_{1903} )}^{2} + {( {b}_{1902} - {b}_{1903} )}^{2}} \times R \qquad ( {7}^{′} )$$

The CPU 102 generates a lightness conversion table for each hue range. In the example of FIG. 19, the lightness of the color 1903, which is the maximum chroma color, is L1903, and the correction amount Mh is a value obtained by multiplying a color difference ΔE 1908 between the color 1901 and the color 1903 by R.

In the example of FIG. 6, the lightness is corrected with the color 603, which is the maximum chroma color, as the reference color. Meanwhile, in the example of FIG. 19, the CPU 102 corrects the lightness with the color 1901, which is the absolute color, as the reference color. That is, it is possible to create the lightness conversion table by performing processing similar to the above with the color 1901 as the reference color and the color 1902 or the color 1903 as the scale color of the example of FIG. 6.

Here, the maximum lightness before the correction is the lightness L1901 of the color 1901, which is the maximum lightness color, and the minimum lightness before the correction is the lightness L1902 of the color 1902, which is the minimum lightness color.

In the example of FIG. 19, the colors 1901 to 1903 converted according to gamut mapping is represented by colors 1905 to 1907, respectively. The lightnesses of the colors 1905 to 1907 are L1905 to 1907, respectively. Further, since the color 1901 is an absolute color and is present in the color gamut 1916, the post-absolute-gamut-mapping color 1905 is the same as the color 1901.

In the example of FIG. 19, a value L1910 obtained by adding the color difference ΔE 1908 to L1905 is calculated with the color 1905 (color 1901) as the reference color, and a color obtained by moving the post-conversion color 1907 of the color 1903 in the lightness direction so as to have the lightness L1910 is indicated as a color 1912. FIG. 20 corresponds to the example of FIG. 19 and is a graph illustrating an example of components of the lightness conversion table according to the present embodiment. Here, similarly to the processing described with reference to FIGS. 6 and 7, a table is generated such that L1910 is outputted with the lightness L1907 of the color 1907 as input and with the lightness L1905 (L1901) of the color 1905, which is a color obtained by converting the reference color, as a reference.

With such processing, it is possible to reduce the extent of color degradation for an absolute color by a change in the lightness direction while maintaining the post-conversion color.

Here, for the sake of descriptive simplicity, description for FIG. 19 has been given assuming that the maximum lightness color is an absolute color. However, so long as an absolute color is maintained by color degradation correction, it is not specifically necessary that the maximum lightness color be an absolute color. If an absolute color has a lightness between the maximum lightness color and the maximum chroma color, it is possible to create the lightness conversion table by performing processing separately for a light color group and a dark color group relative to the reference color, as in the processing of FIG. 6 in which the maximum chroma color is set as the reference color.

In the present embodiment, a lightness conversion table is created for each hue range; however, when processing is performed using a different table for each hue range, it is conceivable that a steep change will occur in the output value depending on whether a boundary of the hue range is crossed. From such a viewpoint, when performing gamut mapping of colors in a given hue range, the CPU 102 may perform processing for converting colors by additionally using the lightness conversion table of one neighboring hue range. The CPU 102 may weight and add a lightness, obtained by converting the lightness of a color in a given hue range using the lightness conversion table for that hue range, and a lightness converted using the lightness conversion table for a neighboring hue range and thereby calculate the lightness of that color after gamut mapping. For example, when performing color conversion of a color C located at a position of a hue angle Hn degrees (here, assumed to be an angle within the hue range 501 of FIG. 5), the CPU 102 can calculate a value Lc of lightness after color conversion as in the following Equation (9).

$$Lc = \vert \frac{Hn - {H}_{502}}{{H}_{502} - {H}_{501}} \vert \times {Lc}_{501} + \vert \frac{Hn - {H}_{501}}{{H}_{502} - {H}_{501}} \vert \times {Lc}_{502} \qquad ( 9 )$$

Here, H₅₀₁ is an intermediate hue angle of the hue range 501 and H₅₀₂ is an intermediate hue angle of a hue range 502. Further, Lc₅₀₁ is a value obtained by converting the lightness of the color C using the lightness conversion table for the hue range 501, and Lc₅₀₂ is a value obtained by converting the lightness of the color C using the lightness conversion table for the hue range 502. With such processing, by performing conversion of lightness taking into account the lightness conversion table of an adjacent hue range, it is possible to prevent a steep change at the boundary of a hue range in an output value obtained by gamut mapping.

As described above, regarding a color that goes out of the color gamut 616 with color degradation correction in which output lightness of the lightness conversion table is used as is, such as the color 612, the CPU 102 according to the present embodiment converts such value after conversion into a value within the color gamut by color difference minimum mapping. In the example of FIG. 6, the color 612 is converted to the color 614 by color difference minimum mapping as described above. Such color difference minimum mapping will be described below.

For example, the CPU 102 can convert the color 612 to a color that is closest to the color 612 among colors that are within the color gamut 616 and are positioned in a predetermined direction from the color 612, by color difference minimum mapping. A relationship between a weight for setting such a predetermined direction and a distance ΔEw from the color 612 to a color after conversion (here, 614) at that time can be expressed by the following Equations (10) to (14).

$$CE = \sqrt{{( {L}_{s} - {L}_{t} )}^{2} + {( {a}_{s} - {a}_{t} )}^{2} + {( {b}_{s} - {b}_{t} )}^{2}} \qquad ( 10 )$$

$$CE = \sqrt{{( {L}_{s} - {L}_{t} )}^{2}} \qquad ( 11 )$$

$$CE = \sqrt{{( {a}_{s} - {a}_{t} )}^{2} + {( {b}_{s} - {b}_{t} )}^{2}} \qquad ( 12 )$$

$$Δ H = Δ E - ( Δ L + Δ C ) \qquad ( 13 )$$

$$Δ H = Wl \times Δ L + Wc \times Δ C + Wh \times Δ H \qquad ( 14 )$$

Here, a pre-conversion color by color difference minimum mapping is set as (Ls, as, bs), and a post-conversion color is set as (Lt, at, bt). Further, as a weight for setting the above predetermined direction, a weight in the lightness direction is expressed as WI, a weight in the chroma direction is expressed as Wc, and a weight of the hue angle is expressed as Wh (Wh+Wl+Wc=1). By finding (Lt, at, bt) that satisfies Equation (14), a color after conversion by color difference minimum mapping is determined.

Here, the values of Wl, Wc, and Wh can be set arbitrarily by the user. In the second embodiment, the degradation-corrected table is created such that the change caused by color degradation correction of a post-conversion color occurs only in the lightness direction; therefore, if it is desired to maintain such an effect as much as possible, it setting the weight in the lightness direction to be greater than other weights can be considered. Further, a hue has a great effect on color appearance; therefore, by setting the weight of a hue angle to be greater (e.g., than the weight of the lightness direction and the weight of the chroma direction), it is possible to prevent change in color appearance before and after color degradation correction. For example, color difference minimum mapping can be performed with the relationship of these weights being Wh>Wl>Wc.

The description has been given assuming that, in color difference minimum mapping, the color 614 is searched for from colors located in a predetermined direction from the color 612. However, the processing of converting a color that is positioned outside the color gamut after degradation correction, such as the color 612, to be within the color gamut is not particularly limited thereto. For example, a color, for which the color 612 has been moved to be within the color gamut 616 by a minimum movement distance so as to maintain a distance from the color 607, may be set to be a post-conversion color of the color 601 after color degradation correction, as the color 614.

In the present embodiment, an example in which color degradation correction is performed such that the change caused by the color degradation correction of a post-conversion color is performed only in the lightness direction has been described. Here, as a characteristic of visual perception, sensitivity to a lightness difference varies depending on chroma. For example, the sensitivity is likely to be higher for a lightness difference between colors low in chroma than a lightness difference between colors higher in chroma than such colors. From this point of view, the CPU 102 according to the present embodiment may perform control such that the lightness direction change amount of a post-conversion color by color degradation correction further varies depending on the chroma value. Here, colors are divided into colors with low chroma and colors with high chroma; regarding the colors with high chroma, the processing is performed as described with reference to FIG. 6 and the like, and regarding the colors with low chroma, the processing is performed so as to decrease the lightness direction change amount of a post-conversion color. Such a color determined to have low chroma will be described below in the context of color degradation correction performed so as to decrease the amount of change in the lightness direction.

When correcting the value of lightness of output of the gamut mapping table to the value of output of the lightness conversion table, the CPU 102 sets Lc′, obtained by internally dividing a lightness value Ln before such correction and a lightness value Lc after such correction by a chroma correction ratio S, as the value of lightness of output of the degradation-corrected table. The chroma correction ratio S is calculated by the following Equation (15) using a chroma value Sn of an output value of gamut mapping and a maximum chroma value Sm of the color gamut after gamut mapping in a hue angle of the output value of gamut mapping. Further, Lc′ is calculated by the following Equation (16).

$$S = \frac{Sn}{Sm} \qquad ( 15 )$$

$${Lc}^{′} = S \times Lc + ( 1 - S ) \times Lc \qquad ( 16 )$$

Here, a condition for when dividing colors into low chroma and high chroma is not particularly limited and can be arbitrarily set according to the user or the environment. For example, a configuration may be taken so as to set a predetermined threshold for chroma and set chroma that is greater than or equal to the threshold as high chroma and chroma less than the threshold as low chroma. Further, a configuration may be taken so as to set the bottom half of detected chroma to be low chroma and the rest to be high chroma, for example. The CPU 102 may perform color degradation correction so as to zero the amount of change in a post-conversion color for a color with low chroma.

With such processing, it is possible to perform color degradation correction that accords with visual sensitivity and prevent a state in which the level of correction is too strong. For example, it is possible to prevent a change due to color degradation correction for colors on a gray axis, for example.

### Third Embodiment

### [Different Hue Repulsive Force]

Even if colors exist in different hue ranges, when a lightness difference becomes small after gamut mapping, it may be difficult to distinguish them. From such a viewpoint, when a lightness difference between two colors after gamut mapping decreases to a predetermined threshold (color difference ΔE) or less, the information processing apparatus 101 according to the present embodiment can perform color degradation correction so as to increase such a lightness difference.

The information processing apparatus 101 according to the present embodiment can perform similar color degradation correction processing to the first embodiment. Differences in the color degradation correction processing performed by the information processing apparatus 101 between the present embodiment and the first embodiment will be described below.

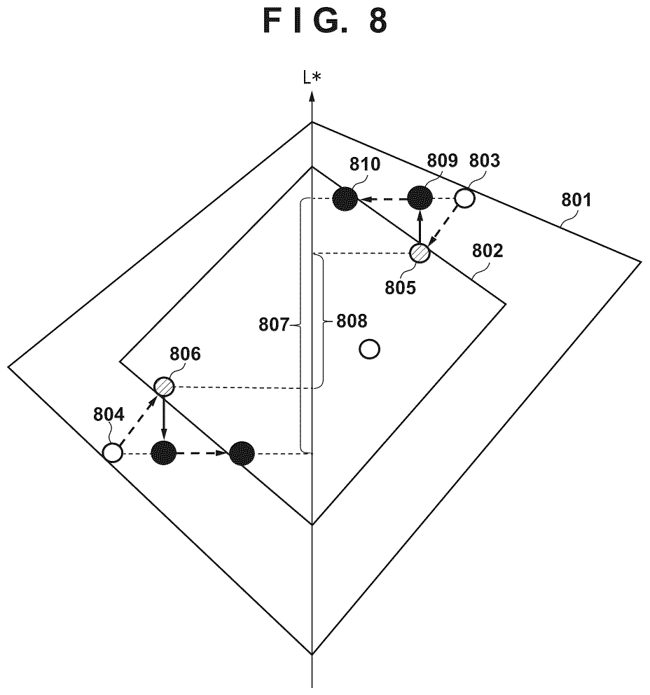

An example of processing for determining whether lightness degradation occurs, performed in step S202 by the information processing apparatus 101 according to the present embodiment, will be described below with reference to FIG. 8. In the present embodiment, as described above, it is assumed that a lightness difference between two colors after gamut mapping decreasing to a predetermined color difference ΔE or less is referred to as lightness degradation. Further, the CPU 102 according to the present embodiment determines that color degradation occurs when lightness degradation occurs.

In step S202, the CPU 102 detects a combination of colors in which lightness degradation occurs among the combinations of unique colors included in the image data based on the unique color list detected in step S201. In FIG. 8, the color gamut of the input image data before being subjected to the color conversion processing is indicated as a color gamut 801, and the color gamut after being converted by gamut mapping is indicated as a color gamut 802 on a plane that uses two axes, an L* axis and a C* axis, in the CIE-L*a*b* color space. The input image data includes a color 803 (first color) and a color 804 (second color), which are illustrated in the color gamut 801. A color 805 and a color 806 are colors in the color gamut 802. The color 805 is a color for when gamut mapping has been performed on the color 803, and color 806 is a color for when gamut mapping has been performed on the color 804. The processing to be described below is repeated for all combinations of unique colors included in the image data.

Here, the CPU 102 determines that a lightness difference has decreased when a lightness difference 808 between color 805 and color 806 is smaller than a lightness difference 807 between color 803 and color 804. Here, it is assumed that a lightness difference in the CIE-L*a*b* color space is calculated. The color information in the CIE-L*a*b* color space is represented using a color space with three axes, L*, a*, and b*. The color 803 is represented using L803, a803, and b803. The color 804 is represented using L804, a804, and b804. The color 805 is represented using L805, a805, and b805. The color 806 is represented using L806, a806, and b806. When the input image data is represented by another color space, the input image data may be converted to the CIE-L*a*b* color space by a known color space conversion technique, and subsequent processing may be performed as is in that color space. The lightness difference ΔL 807 and the lightness difference ΔL 808 are calculated by the following Equations (17) and (18), for example.

$$Δ {L}_{807} = \sqrt{{( {L}_{803} - {L}_{804} )}^{2}} \qquad ( 17 )$$

$$Δ {L}_{808} = \sqrt{{( {L}_{805} - {L}_{806} )}^{2}} \qquad ( 18 )$$

When the lightness difference ΔL 808 is smaller than the lightness difference ΔL 807, the CPU 102 determines that the lightness difference has decreased. Further, when the lightness difference ΔL 808 is less than or equal to a predetermined threshold, the CPU 102 determines that these colors do not have a difference with which it is possible to distinguish a difference between the colors and thus lightness degradation has occurred.

If the lightness difference between the color 805 and the color 806 is a magnitude at which the colors can be distinguished to be different in terms of characteristics of visual perception of humans, it can be determined that there is no need to correct the lightness difference. From such a viewpoint, the threshold used here may be, for example, 0.5. When the lightness difference ΔL 808 is smaller than the lightness difference ΔL 807 and when the lightness difference ΔL 808 is smaller than 0.5, the CPU 102 may determine that lightness degradation has occurred.

Next, the color degradation correction processing performed in step S205 according to the present embodiment will be described with reference to FIG. 8.

The CPU 102 according to the present embodiment can calculate a correction ratio T, which is a reflection rate of correction of the conversion parameter in color degradation correction, based on a ratio of the number of combinations of colors in which lightness degradation occurs to the total number of combinations of colors in the unique color list. For example, the CPU 102 according to the present embodiment calculates the correction ratio T as follows.

T=number of combinations of colors in which lightness degradation occurs/number of combinations of colors in unique color list

The above correction ratio T decreases as a proportion of the combinations of colors in which lightness degradation occurs within the unique color list decreases and increases as the proportion increases. By performing correction of the conversion parameter using such a correction ratio, it is possible to increase the level of correction of color degradation as the proportion of the combinations of colors in which lightness degradation occurs increases.

Next, the CPU 102 performs lightness difference correction based on lightness before gamut mapping and the correction ratio T. The lightness Lc after lightness difference correction can be calculated by, for example, the following Equation (19) as a value obtained by internally dividing a gap between the lightness Lm before gamut mapping and the lightness Ln after gamut mapping by the correction ratio T.

$$Lc = T \times ( Lm - Lc ) + Ln \qquad ( 19 )$$

Such lightness difference correction is repeated for all the unique colors in the input image data. In FIG. 8, the lightness L805 of the color 805 is subjected to lightness difference correction using the correction ratio T, and a result of that correction is indicated as a color 809. In the example of FIG. 8, the color 809 is outside of the color gamut 802 after gamut mapping and thus is mapped to the color gamut 802 and becomes a color 810. Similar processing is performed on the color 804. With such processing, it is possible to perform gamut mapping in which the lightness difference is widened for colors included in the image data, and in a case where lightness degradation occurs, it is possible to reduce the extent thereof. Therefore, by preventing a state in which the lightness difference after gamut mapping becomes too small, it is possible to reduce a decrease in distinguishability.

The processing for reducing lightness degradation according to the present embodiment may be performed simultaneously with the processing according to the second embodiment. In that case, the lightness difference correction processing is performed on the reference color of the color degradation correction processing. In conjunction with correcting the lightness difference of the reference color, lightness difference correction of other colors can also be processed. With such a configuration, when performing color degradation correction, it is possible to reduce the extent of lightness degradation in addition to the extent of color degradation.

### Fourth Embodiment

### [Area Setting]

In the first to third embodiments, the color degradation correction processing is performed with all the unique colors included in the input image data as processing targets. However, in some cases, it may be preferable to set a different priority for each area in the input image data and perform different gamut mapping for each thereof.

For example, a color used in a graph and a color used as part of a gradient may be different in the significance that the color has in the context of distinguishing. For example, regarding a color used in a graph, distinguishability from another color in the graph is important; therefore, it is conceivable to perform color degradation correction with a high level of color degradation correction. Meanwhile, regarding a color used as part of a gradient, tonality with colors of surrounding pixels is important; therefore, it is conceivable to perform color degradation correction with a low level of color degradation correction. When these two colors are the same color and are included in the same input image data, it is preferable to perform color degradation correction with a relatively high level of color degradation correction for the color of the graph and perform color degradation correction with a relatively low level of color degradation correction for the color used as part of a gradient. Such a state may occur especially when the inputted original data includes a plurality of pages of image data, and processing for color degradation correction is performed on such a plurality of pages.

Similarly, even if a color is that for which it is desired to retain an absolute color appearance, such as a corporate color, there are cases in which it is not necessary to retain the color, which serves as an absolute color, such as when it is used only in a few pixels in a gradient. Therefore, if the absolute gamut mapping of step S104 is performed only based on the condition that a registered absolute color is present in the original, there is a possibility that unintended color degradation correction, such as loss of tonality in the gradient, may be performed.

The information processing apparatus 101 according to the present embodiment sets a plurality of partial areas in the image data and performs processing from step S102 onward of the first embodiment for each of those partial areas. That is, the information processing apparatus 101 according to the present embodiment creates a degeneration-corrected table for each partial area. In particular, if there are a plurality of images, a plurality of partial areas may be set from among those images.

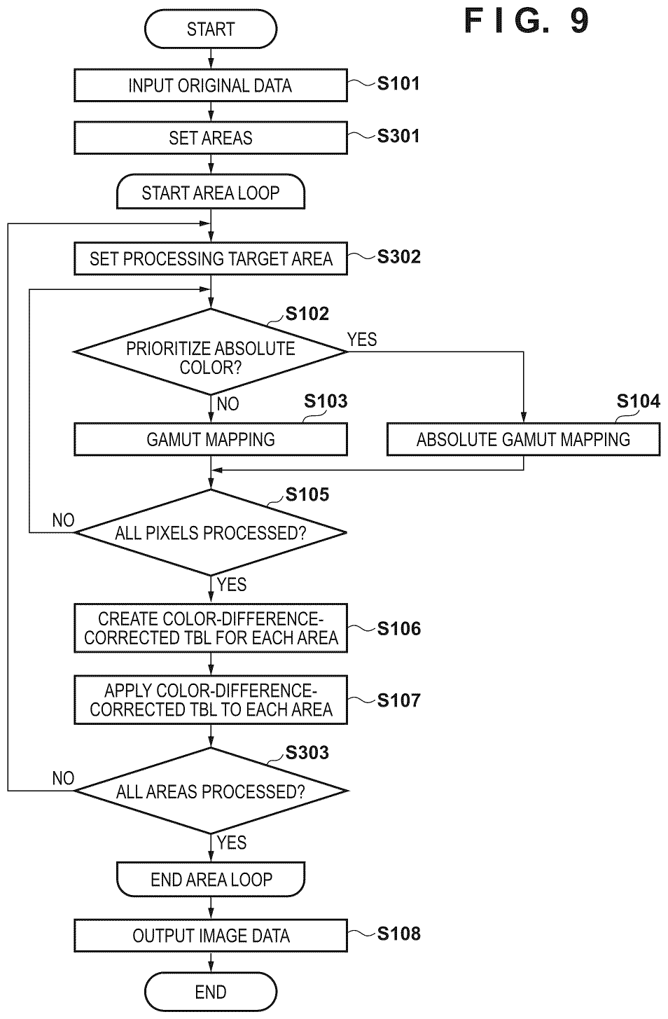

FIG. 9 is a flowchart for explaining an example of the overall processing to be performed by the information processing apparatus 101 according to the present embodiment. The processing indicated in FIG. 9 is performed in the same manner as the flow indicated in FIG. 2 of the first embodiment except that steps S301 and S302, which follows step S101, and step S303, which follows step S107, are additionally performed; therefore, duplicate explanation will be omitted.

In step S301, which follows step S101, the CPU 102 sets a partial area in the original data obtained in step S101. Here, it is assumed that at least two partial areas are set. The partial area according to the present embodiment may be set based on information included in the original data, may be set based on an image of the original data (e.g., as an area in which pixel values satisfy a predetermined condition), or may be set based on user input for setting a partial area.

Steps S302 to S303 are loop processing in which one of the partial areas set in step S301 is set as a processing target. In step S302, the CPU 102 sets one of the partial areas set in step S301 as a processing target and advances the processing to step S102. In steps S102 to S107 indicated in FIG. 9, processing similar to that of FIG. 3 is performed on the processing target set in step S302.

In step S303, which follows step S107, the CPU 102 determines whether all of the partial areas set in step S301 have been set as a processing target. If all of the partial areas have been set as a processing target, the processing proceeds to step S108; otherwise, the processing returns to step S302.

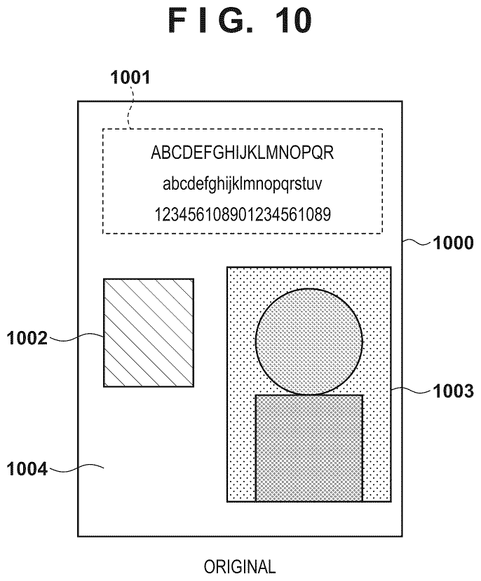

The processing for setting partial areas in step S301 will be described in detail. FIG. 10 is a diagram for explaining an example of a page of original data inputted in step S301 of FIG. 9, according to the present embodiment. Here, it is assumed that document data included in the original data is described in PDL. PDL is an abbreviation of Page Description Language and is constituted by a set of drawing commands in units of pages. The types of drawing commands are defined for each PDL specification, and any type can be adopted; however, in the present embodiment, the following three types of commands 1 to 3 are used as an example.
Command 1) TEXT drawing command (X1, Y1, color, font information, text string information)
Command 2) BOX drawing command (X1, Y1, X2, Y2, color, fill pattern)
Command 3) IMAGE drawing command (X1, Y1, X2, Y2, image file information)

Other types of drawing commands may be used depending on the application, such as a DOT drawing command for drawing a point, a LINE drawing command for drawing a line, or a CIRCLE drawing command for drawing an arc. For example, conventional PDL, such as Portable Document Format (PDF) proposed by Adobe, XPS proposed by Microsoft, or HP-GL/2® proposed by Hewlett Packard (HP), may be used.

An original page 1000 of FIG. 10 represents one page of document data. As an example, regarding the document data, it is assumed that the number of pixels is 600 pixels in width and 800 pixels in height. An example of PDL corresponding to the document data of the original page 1000 of FIG. 10 will be described below.

<PAGE = 001>
<TEXT> 50, 50, 550, 100, BLACK, STD-18,
“ABCDEFGHIJKLMNOPQR” </TEXT>
<TEXT> 50, 100, 550, 150, BLACK, STD-18,
“abcdefghijklmnopqrstuv” </TEXT>
<TEXT> 50, 150, 550, 200, BLACK, STD-18,
“1234567890123456789” </TEXT>
<BOX> 50, 350, 200, 550, SPOT1, STRIPE </BOX>
<IMAGE> 250, 300, 580, 700, “PORTRAIT.jpg”
</IMAGE>
</PAGE>

The description from <PAGE=001> (first line) to </PAGE> (11th line) will be described below. Here, objects including text, graphics (box or square), and image data included in the original data are described by respective descriptions. Here, description will be given assuming that three types of objects, text, graphics, and image data, are used; however, different types of objects may be used. For example, a type of object indicating that it is a partial area in which spot color printing is performed may be used.

<PAGE=001> of the first line is a tag that indicates the page number of the original data according to the present embodiment. PDL is usually designed to be capable of describing a plurality of pages; therefore, a tag that indicates a separation between pages is described in PDL. In this example, the description up to </PAGE> represents the first page. The present embodiment corresponds to the original page 1000 of FIG. 10. When there is a second page, <PAGE=002> is described following the above PDL.

The description from <TEXT> of the second line to </TEXT> of the third line is a drawing command 1 (first TEXT command) describing text as an object and corresponds to the first line of an area 1001 of FIG. 10. The first two coordinates indicate coordinates (X1, Y1), which is the upper left of a drawing area, and the next two coordinates indicate coordinates (X2, Y2), which is the lower right of the drawing area. Then, it is described that the color of the text is BLACK (black: R=0, G=0, B=0), that the font of the text is “STD” (standard), that the text size is 18 points, and that the text string to be described is “ABCDEFGHIJKLMNOPQR”.

The description from <TEXT> of the fourth line to </TEXT> of the fifth line is a drawing command 2 (second TEXT command) describing text as an object and corresponds to the second line of the area 1001 of FIG. 10. Similarly to the command 1, the first four coordinates and two text strings represent the drawing area and the text color and font of the text, respectively, and describe that the text string to be described is “abcdefghijklmnopqrstuv”.

The description from <TEXT> of the sixth line to </TEXT> of the seventh line is a drawing command 3 (third TEXT command) describing text as an object and corresponds to the third line of the area 1001 of FIG. 10. Similarly to the drawing command 1 and the drawing command 2, the first four coordinates and two text strings represent the drawing area and the text color and font of the text, respectively, and describe that the text string to be described is “1234567890123456789”.

The description from <BOX> to </BOX> of the eighth line is a drawing command 4 (BOX command) describing a box as an object and corresponds to an area 1002 of FIG. 10. The first two coordinates indicate upper left coordinates (X1, Y1), which is a drawing start point, and the next two coordinates indicate lower right coordinates (X2, Y2), which is a drawing end point. Then, SPOT1 (spot color 1: R=R01, G=G01, B=B01) is designated as the fill color of the area, and STRIPE (striped pattern), which is a striped pattern, is designated as the fill pattern. In the present embodiment, regarding the direction of the striped pattern, the lines are directed to the lower right; however, it may be possible to designate the angle, period, and the like of the line in the BOX command. Unlike drawing commands 1 to 3, the color of the line is SPOT1 in the drawing command 4. In the present embodiment, it is assumed to indicate that it is the color that is registered first in the spot colors and is “C red”, which is registered as the first color in FIG. 16. However, a substantive industry standard is already recognized and administered in the printing industry; therefore, a spot color may be described using a name (such as a Pantone color patch name) in that substantive industry standard.

The IMAGE command of the ninth and 10th lines is a drawing command 5 (IMAGE command) describing designation of image data as an object and corresponds to an area 1003 of FIG. 10. Here, it is described that the file name of the image present in the area is “PORTRAIT.jpg”, and this indicates that the image data is a Joint Photographic Experts Group (JPEG) file, which is a commonly used image compression format. </PAGE> described in the 11th line indicates that the drawing of the corresponding page ends.

Regarding actual PDL files, there are cases where the file, as a whole, includes “STD” font data and the “PORTRAIT.jpg” image file in addition to the above drawing command group. This is because, when the font data and the image file are managed separately, the text portion and the image portion cannot be formed by the drawing commands alone, and the information is insufficient to form the image of FIG. 10. Further, an area 1004 in FIG. 10 is an area for which there is no drawing command and thus is blank.

As described above, the CPU 102 according to the present embodiment may set a partial area based on information included in the original data, may set a partial area based on an image of the original data (e.g., as an area in which pixel values satisfy a predetermined condition), or may set a partial area based on user input for setting a partial area. When a partial area is set based on information included in the original data, such as a case of the original page described in PDL as in the original page 1000 of FIG. 10, a partial area can be extracted by analyzing the above PDL. Specifically, each drawing command is described such that each of the start point and the end point of Y coordinates of the object are as follows. The objects of respective TEXT commands are contiguous in terms of area. In addition, both the BOX command and the IMAGE command are separated from the TEXT commands by 100 pixels or more in the Y direction.

| Drawing Command | Y Start Point | Y End Point |
|---|---|---|
| First TEXT Command | 50 | 100 |
| Second TEXT Command | 100 | 150 |
| Third TEXT Command | 150 | 200 |
| BOX Command | 350 | 550 |
| IMAGE Command | 300 | 700 |

Next, the BOX command and the IMAGE command are described such that each of the start point and the end point of the X coordinates of each object are as follows. The X coordinates of the object of each TEXT command are the same for the start point and the end point. In addition, the objects drawn by the BOX command and the IMAGE command are 50 pixels apart in the X direction.

| Drawing Command | X Start Point | X End Point |
|---|---|---|
| BOX Command | 50 | 200 |
| IMAGE Command | 250 | 580 |

Based on the above, in the example of FIG. 10, the CPU 102 can set the following three areas as partial areas.

| Area | X Start Point | Y Start Point | X End Point | Y End Point |
|---|---|---|---|---|
| First Area | 50 | 50 | 550 | 200 |
| Second Area | 50 | 350 | 200 | 550 |
| Third Area | 250 | 300 | 580 | 700 |

As described above, the CPU 102 can set a partial area based on the description related to drawing of an object included in the original data. Further, in addition to the configuration for setting a partial area by analyzing PDL as described above, the CPU 102 can divide an image into a plurality of divided areas and set a partial area based on such divided areas. Here, for example, a configuration may be taken so as to divide an image into unit tiles to be described later and set one or more such unit tiles as a partial area. Such a configuration will be described below.

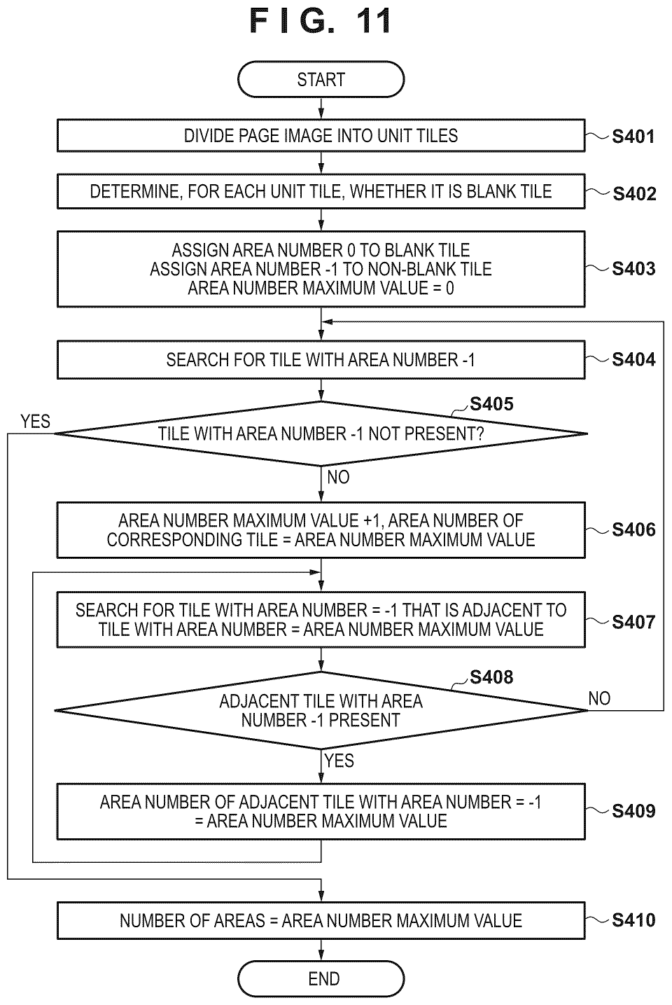

FIG. 11 is a flowchart for explaining an example of detailed processing for when the partial area setting processing of step S301 is performed in units of tiles. In step S401, the CPU 102 sets a unit tile of the original page (hereinafter, may be simply referred to as “tile”) and divides the original page into such tiles. In the present embodiment, it is assumed that the unit tile in the original page is set to a tile that is 30 pixels in both the vertical and horizontal directions. Since the original page is 600×800 pixels as described above, there are 20 tiles in the X direction and 27 tiles in the Y direction (assume that a tile that cannot be fully drawn is also counted as one tile), each tile being 30 pixels in both the vertical and horizontal directions. In order to set such a unit tile, a variable for setting an area number for each tile is set as area_number [20] [27].

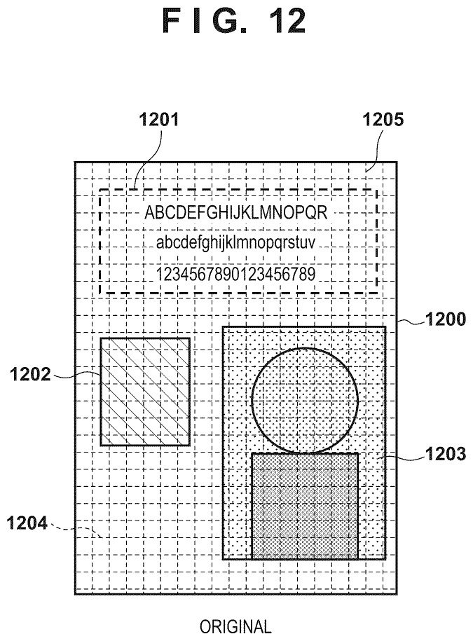

FIG. 12 is a diagram illustrating a conceptual image of tile setting of the original page in the present embodiment. In FIG. 12, an original page 1200 represents the entire original page. An area 1201 is an area in which text is drawn, an area 1202 is an area in which a shape is drawn, an area 1203 is an area in which image data is drawn, and an area 1204 is an area in which no object is drawn. In the following, when designating a tile that is thus arranged on the original page, it may be referred to as a tile (x, y) indicating a tile that is x-th from the left and y-th from the top.

In step S402, the CPU 102 determines, for each tile, whether it is a blank tile. Here, if the tile is not overlapped with an object, it is determined to be a blank tile; otherwise, it is determined not to be a blank tile. The CPU 102 may determine whether the tile is a blank tile by comparing the coordinates of the tile with the start and end points of the XY coordinates of each object described by a drawing command as described above or may detect a tile in which pixel values in the actual unit tile are all R=G=B=255 as a blank tile. Whether to perform this determination by comparing the coordinates or based on the pixel values in the tile can be set based on processing accuracy, detection accuracy, and the like.

In steps S403 to S410, an area number is set for each tile. In step S403, the CPU 102 sets, for each tile, an initial value of each value, including the area number, as follows.
An area number “0” is set for a tile determined to be a blank tile in step S402.
An area number “−1” is set for a (non-blank) tile other than the above.
An area number maximum value is set to “0”.

Specifically, the initial value of each value is set as follows.
blank tile (x1, y1) area_number [x1] [y1]=0
non-blank tile (x2, y2) area_number [x1] [y1]=−1
area number maximum value max_area_number=0

Therefore, when the processing of step S402 is completed, “0” or “−1” is set for all tiles.

In step S404, the CPU 102 detects a tile with an area number “−1”. Here, the CPU 102 performs determination on a range of x=0 to 19 and y=0 to 26 for the tile (x, y) as follows. When a tile with an area number “−1” is first detected or when detection processing has been completed with all the tiles having been set as the target, the processing proceeds to step S405 with a detected tile as a processing target.
if (area_number [x] [y]=−1)→detected
else→not detected

In step S405, the CPU 102 determines whether a tile with the area number “−1” has been detected in step S404. If a tile has been detected, the processing proceeds to step S406; otherwise, the processing proceeds to step S410.

In step S406, the CPU 102 increments the area number maximum value by +1 and sets the area number of the tile detected with the area number “−1” to the updated area number maximum value. Specifically, a detected tile (x3, y3) is processed as follows.
max_area_number=max_area_number+1
area_number [x3] [y3]=max_area_number

For example, here, when a tile is detected for the first time by the detection processing of step S404 and the processing of step S406 is executed for the first time thereon, the area number maximum value after the update is “1”, and thus, the area number of that tile is “1”. Thereafter, each time step S406 is executed again, the area number maximum value is increased by one.

Then, in steps S407 to S409, processing for extending successive non-blank areas as the same area is performed. In step S407, the CPU 102 detects a tile with an area number “−1” that is adjacent to the tile whose area number is the area number maximum value. Specifically, the following determination is performed for the tile (x, y) in a range of x=0 to 19 and y=0 to 26. When a tile with an area number “−1” is first detected or when detection processing has been completed with all the tiles having been set as the target, the processing proceeds to step S408 with a detected tile as a processing target.
if (area_number [x] [y]=max_area_number)
if ((area_number [x−1] [y]=−1) or
(area_number [x+1] [y]=−1) or
(area_number [x] [y−1]=−1) or
(area_number [x] [y+1]=−1))→detected
else→not detected

In step S408, the CPU 102 determines whether a tile with the area number “−1” has been detected in step S407. If a tile has been detected, the processing proceeds to step S409; otherwise, the processing returns to step S404.

In step S409, the CPU 102 updates the area number of a tile with an area number “−1” that is an adjacent tile to the area number maximum value at that time. Specifically, the detected adjacent tile is processed as follows with the position of a tile of interest being (x4, y4).
if ((area_number [x4−1] [y4]=−1)
   area_number [x4−1] [y4]=max_area_number
if ((area_number [x4+1] [y4]=−1)
   area_number [x4+1] [y4]=max_area_number
if ((area_number [x4] [y4−1]=−1)
   area_number [x4] [y4−1]=max_area_number
if ((area_number [x4] [y4+1]=−1)
   area_number [x4] [y4+1]=max_area_number

When the area number of the adjacent tile is updated in step S409, the processing returns to step S407, and detection of another adjacent non-blank tile is continued. Then, when there is no non-blank adjacent tile that has not been detected, that is, there are no more tiles to which that maximum area number is to be assigned, the processing returns to step S404. When the area number of all the tiles is not “−1”, that is, all tiles are blank tiles, or when an area number that is 0 or higher is set for all the tiles, in step S405 it is determined that there is no tile with an area number “−1”.

In step S410, the CPU 102 sets the area number maximum value as the number of areas and terminates the processing of FIG. 11. That is, the area number maximum value that has been set thus far is the number of areas present in the original page.

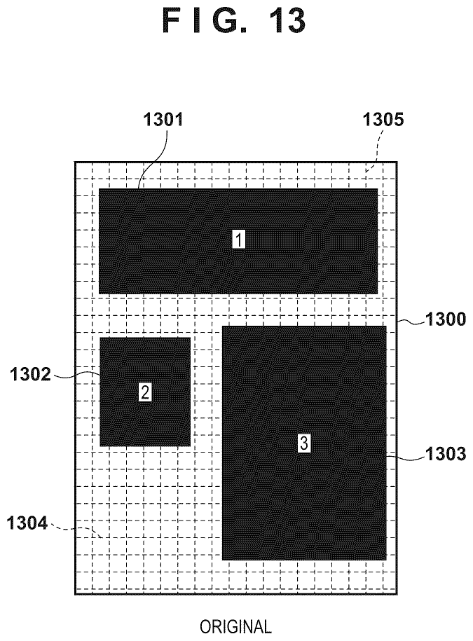

FIG. 13 is a diagram illustrating each tile area after area setting has been completed. An original page 1300 of FIG. 13 represents the entire original page corresponding to the original page 1200. An area 1301 of FIG. 13 is an area in which text is drawn, an area 1302 is an area in which a shape is drawn, an area 1303 is an area in which image data is drawn, and an area 1304 is an area in which no object is drawn. Here, a result of area setting is as follows.
Number of areas=3
   Area number=0 blank region 1304
   Area number=1 text region 1301
   Area number=2 box region 1302
   Area number=3 image region 1303

In the example illustrated in FIG. 13, each area is spatially separated by at least one blank tile. In other words, a plurality of tiles not interposed even by one blank tile are assumed to be adjacent to each other and are processed as the same area. By doing so, even when there is an area constituted by a color for which it is desired to retain an absolute color appearance, such as a corporate color, at a fixed distance from another area, it is possible to separately apply processing in which an absolute gamut mapping table is used and color degradation correction in which the color appearance of an absolute color is not prioritized to each of the areas.

Human vision has a characteristic that a difference between two colors that are spatially adjacent or present in very close positions is relatively easy to perceive, while a difference between two colors present in spatially isolated positions is relatively difficult to perceive. That is, the above results that are “outputted in different colors” are more likely to be perceived when processing is performed on the same colors that are spatially adjacent or present at very close positions, and less likely to be perceived when processing is performed on the same color that is present in spatially isolated positions.

In the processing according to the present embodiment, areas deemed to be different areas are separated by a predetermined minimum distance or more on a paper surface. This also means that pixel positions deemed to be in the same area are present within such a minimum distance across a background color (e.g., white, black, or gray). The minimum distance is determined by the size of the unit tile and can be arbitrarily set according to the size of paper on which printing is to be performed, an observation distance assumed by the user, or the like. In the present embodiment, it is assumed that printing is performed on a printing sheet of an A4 size and that the minimum distance is 0.7 mm or more. Even if the distance between such objects is not separated by the minimum distance on the paper surface, if they are set to be different objects, they may be assumed as different areas. For example, if there are an image area and a box area that are not separated by a predetermined distance, since they are of different object types, they may be set as different areas. By doing so, even when an area constituted by a corporate color or the like is present close to another area, it is possible to separately apply processing in which an absolute gamut mapping table is used and color degradation correction in which the color appearance of an absolute color is not prioritized.

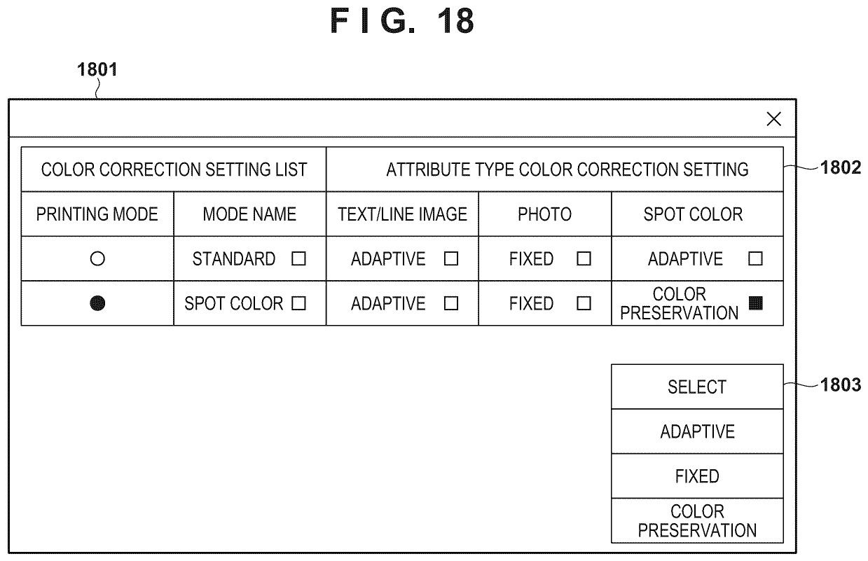

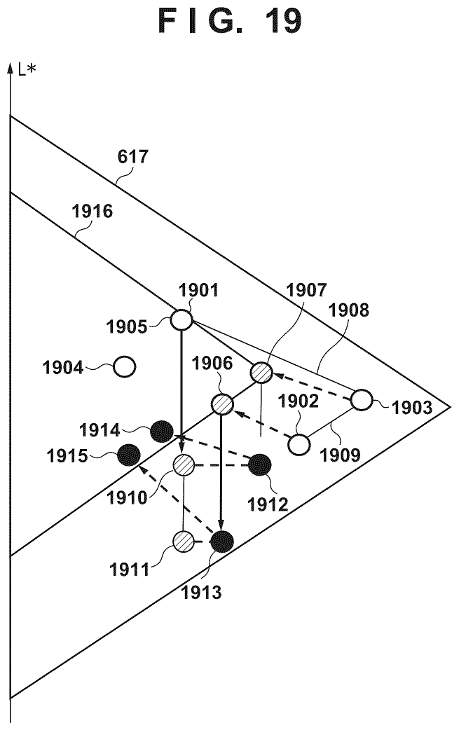

Further, description has been given assuming that in the determination of step S102, when it is determined that predetermined color information is included in the processing target data, the subsequent processing transitions to step S106 in which absolute gamut mapping is performed. However, when it is expected that an area constituted by a corporate color is a particular type of object, for example, it is conceivable that absolute gamut mapping will not need to be performed for an object that is not of such a particular type even if the predetermined color information is included. From such a viewpoint, when a partial area, which is an area of an object in the image, is a particular type of object in addition to that area including particular color information, the CPU 102 according to the present embodiment may perform absolute gamut mapping. Such a particular type of object may be arbitrarily set and may be set via a UI, such as that illustrated in FIG. 18, for example.

In the present embodiment, it is assumed that the CPU 102 sets an area of an object in an image as a partial area and determines whether the type of that object (included in the description of the object) is a particular type. Then, if that partial area includes predetermined color information and that object is of a particular type, the CPU 102 can select color conversion processing so as to perform absolute gamut mapping.

Here, a color correction setting dialog 1801 illustrated in FIG. 18, which is displayed when the “set color correction” button in FIG. 15 is pressed will be described below. FIG. 18 is a diagram illustrating a dialog for setting a color correction method. Determination criteria set here are used in step S102 of FIG. 9, for example. In the color correction setting dialog 1801, a color correction setting list display portion 1802 and a selection dialog 1803 are displayed.

Here, in the color correction setting list display portion 1802, a color correction setting list is displayed. The color correction setting list stores, as items for setting color correction, a radio button for selecting a printing mode (one of which is always in a selected state), a mode name (standard or spot color; it is possible to register and delete other names), and an attribute type color correction setting (text/line image, photo, or spot color). In the example illustrated in FIG. 18, two modes, which are standard (text/line image=adaptive, photo=fixed, spot color=adaptive) and spot color (text/line image=adaptive, photo=fixed, spot color=color preservation) are registered as mode names. Which mode is selected at the time of actual printing is specified by the “printing mode” radio button at the beginning, and in the example illustrated in FIG. 18, the setting state is that in which “printing is performed in the spot color mode”.

By accepting a pressing operation of the user on a mode name button of the color correction setting dialog 1801, the CPU 102 can add, update, or remove a printing mode. Since an operation such as adding a printing mode can be performed similarly to the operation on the registration and deletion dialog 1603 described with reference to FIG. 17, the description thereof will be omitted.

The selection dialog 1803 is a dialog for updating the contents of processing on “spot color” input data during the “spot color mode”. Here, the selection dialog 1803 is displayed by a “color preservation” button displayed in the lower right of the color correction setting list display portion 1802 being pressed by the user.

In the selection dialog 1803, three selection buttons, which are an “adaptive” button, a “fixed” button, and a “color preservation” button, are displayed. The processes performed when the three selection buttons are pressed are processing for performing “adaptive” color degradation correction gamut mapping, processing in which color degradation correction level=0 in the above “adaptive” processing, and absolute gamut mapping performed in step S104, respectively. Here, when the user presses the “adaptive” button,
“color correction setting at the time of spot color” of “spot color” printing mode=“adaptive”
   is set, and the lower right “color preservation” display in the color correction setting list display portion 1802 is updated to “adaptive”. In this case, color correction of the “standard” printing mode and the “spot color” printing mode is the same processing.

Similarly, when the user presses the “fixed” button in the color correction setting list display portion 1802,
color correction setting at the time of spot color of “spot color” printing mode=“fixed”
   is set, and the lower right “color preservation” display in the color correction setting list display portion 1802 is updated to “fixed”.

In addition, when the user presses the “adaptive” button, the setting does not change.

In PDL illustrated in FIG. 10 according to the present embodiment, regarding a text/line image, a photo, and a spot color in the “attribute type color correction setting”, each object that satisfies the following criteria is a target.
Text/line image A TEXT command or BOX command object for which a color is not designated as a spot color (SPOT)
   Photo An IMAGE command object
   Spot color A TEXT command or BOX command object for
      which a color is designated as a spot color (SPOT)

As a result, respective areas in FIG. 13 are determined to be:
Area 1301→Text/line image
   Area 1302→Spot color
   Area 1303→Photo
      and as a result, the color correction of respective areas is:
Area 1301→Text/line image→Adaptive
Area 1302→Spot color→Color Preservation
Area 1303→Photo→Fixed

As actual processing, when an area is one area constituted by a plurality of drawing commands, if there is even one object determined to be a spot color in the area, all objects in the area may be processed according to absolute gamut mapping. In this case, it can be made easier to maintain color connection of the boundary portion between the objects. Further, as described above, when object types are different, they may be determined to be different areas. In this case, color degradation correction set to be suitable for each object is applied.

With such a configuration, it is possible to set a plurality of partial areas in the image data and create degeneration-corrected table in each thereof. Further, according to this processing, it is possible to perform similar color degradation correction for separated objects if the objects are of the same color distribution and the same type. Further, by thus performing color degradation correction processing for each partial area, it is possible to limit the number of combinations of colors to be subjected to color degradation correction processing and improve the processing speed.

In the present embodiment, description has been given assuming that the information of an object is included in the original data (as described with reference to FIG. 10). However, so long as an object in the image can be identified, it is not particularly necessary that the original data includes the type of the object. For example, the CPU 102 may detect a particular object in the image. In that case, for example, the position of the object can be the position of a bounding box that includes the object, and the type of the object can be set by classifying the class of the detected object. Such processing for detecting an object in the image can be performed by a known object recognition technique in which a neural network is used, for example.

Further, in the present embodiment, description has been given assuming that a partial area of the original data is set in step S301. Here, as described above, a configuration in which the original data includes a plurality of pages of image data and partial areas are set from among the plurality of pages may be taken. In particular, a configuration may be taken so as to set the entire image data of one page (or more) in the image data of a plurality of pages as a partial area relative to the entire original data. An example in which one page of image data is set as a partial area (partial page) will be described below.

Here, as described above, the original data to be printed is document data constituted by a plurality of pages. The “partial page” is information for setting one or more of the plurality of pages included in the document data collectively as a target for which to create a degradation-corrected gamut mapping table described above. For example, it is assumed that document data is constituted by a first page to a third page. If each page is set as a target for which to create a separate mapping table, the first page, the second page, and the third page each will be a partial page. In addition, if the first and second pages and the third page are respectively set as a target for which to create a mapping table, the “first and second pages” and the “third page” will be partial pages. That is, the CPU 102 can separately apply processing in which an absolute gamut mapping table is used and color degradation correction in which the color appearance of an absolute color is not prioritized to each of such partial pages.

The “partial page” used here is not limited to a complete page unit included in the document data. For example, a partial area of the first page may be set as a “partial page”. In this case, in step S301, the CPU 102 sets the original data to a plurality of “partial pages” according to a predetermined complete “partial page”. The complete “partial page” may be designated by the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU), or the like) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-201023, filed Nov. 28, 2023, which is hereby incorporated by reference herein in its entirety.

What is claimed is:

1. An information processing apparatus comprising:
at least one processor configured to function as:
an obtaining unit configured to obtain first color information from an image that includes a pixel representing color information of a first color defined in a first color gamut and a pixel representing color information of a second color defined in the first color gamut;
a setting unit configured to set second color information indicating particular color information;
a conversion unit configured to execute, on the image, color conversion processing for converting the first color into a third color defined in a second color gamut and converting the second color into a fourth color defined in the second color gamut; and
a first correction unit configured to:
in a case where a color difference between the third color and the fourth color is less than a predetermined threshold,
in a case where the first color is not included in the particular color information, correct a conversion parameter in the color conversion processing such that a color obtained by converting the first color is a fifth color whose color difference from the fourth color is greater than the color difference between the third color and the fourth color and which is defined in the second color gamut, and
in a case where the first color is included in the particular color information, correct a conversion parameter in the color conversion processing such that a color obtained by converting the second color is a sixth color whose color difference from the third color is greater than the color difference between the third color and the fourth color and which is defined in the second color gamut.

2. The information processing apparatus according to claim 1, wherein
the predetermined threshold is smaller than the color difference between the first color and the second color.

3. The information processing apparatus according to claim 1, wherein
the predetermined threshold is 2.0 in Euclidean distance ΔE.

4. The information processing apparatus according to claim 2, wherein
the first color and the second color are colors expressed in any color space among CIE-L*a*b*, RGB, HLS, and HSV.

5. The information processing apparatus according to claim 1, wherein the second color gamut is a color reproduction gamut for printing by an image forming apparatus.

6. The information processing apparatus according to claim 1, wherein the at least one processor is further configured to function as:
a grouping unit configured to group colors included in the image according to a hue range,
wherein the first color information including the first color and the second color is color information of a hue range according to which grouping has been performed by the grouping unit.

7. The information processing apparatus according to claim 6, wherein the sixth color is a color calculated based on the third color, the fourth color, and the color difference between the first color and the second color.

8. The information processing apparatus according to claim 7, wherein the sixth color is a color obtained by correcting a lightness of the fourth color based on the color difference between the first color and the second color.

9. The information processing apparatus according to claim 8, wherein the sixth color is a color obtained by setting the lightness of the fourth color to be a value obtained by adding the color difference between the first color and the second color to a lightness of the third color.

10. The information processing apparatus according to claim 7, wherein the sixth color is a color obtained by mapping, in the second color gamut, a color obtained by setting a lightness of the fourth color to be a value obtained by adding the color difference between the first color and the second color to a lightness of the third color.

11. The information processing apparatus according to claim 7, wherein the conversion unit converts a seventh color which is different from the first color and the second color included in the first color information into an eighth color defined in the second color gamut, and
the eighth color is a color calculated based on the third color, the fourth color, and a ninth color which is a color for when the seventh color has been converted according to the color conversion processing before correction of the conversion parameter by the first correction unit.

12. The information processing apparatus according to claim 7, wherein
the second color is a color with the highest chroma among colors included in the first color information.

13. The information processing apparatus according to claim 12, wherein
the first color is a color with the greatest lightness or a color with the least lightness among colors included in the first color information.

14. The information processing apparatus according to claim 6, wherein the at least one processor is further configured to function as:
a determination unit configured to determine whether two colors are recognized to be the same color based on a hue range,
wherein the grouping unit groups colors determined to be the same color by the determination unit.

15. The information processing apparatus according to claim 14, wherein
the determination unit recognizes colors in a hue range from 30 degrees to 60 degrees as the same color.

16. The information processing apparatus according to claim 1, wherein the at least one processor is further configured to function as:
a second correction unit configured to correct a correction amount of the conversion parameter by the first correction unit based on a ratio of a total number of combinations of colors included in the first color information and the number of combinations of colors whose color difference after conversion according to the color conversion processing is smaller than the predetermined threshold and which are included in the first color information.

17. The information processing apparatus according to claim 1, wherein
the particular color information includes a plurality of colors.

18. The information processing apparatus according to claim 1, wherein
the obtaining unit obtains the first color information from an image of a partial area in the image.

19. The information processing apparatus according to claim 18, wherein
the partial area is an area constituted by one or more divided areas obtained by dividing the image into a plurality of areas.

20. The information processing apparatus according to claim 1, wherein
in a case where the first color is included in the particular color information, the first correction unit corrects the conversion parameter in the color conversion processing such that a color obtained by converting the second color is a sixth color and a color obtained by converting the first color is the first color.

21. An information processing method comprising:
obtaining first color information from an image that includes a pixel representing color information of a first color defined in a first color gamut and a pixel representing color information of a second color defined in the first color gamut;
setting second color information indicating particular color information;
executing, on the image, color conversion processing for converting the first color into a third color defined in a second color gamut and converting the second color into a fourth color defined in the second color gamut; and
in a case where a color difference between the third color and the fourth color is less than a predetermined threshold,
in a case where the first color is not included in the particular color information, correcting a conversion parameter in the color conversion processing such that a color obtained by converting the first color is a fifth color whose color difference from the fourth color is greater than the color difference between the third color and the fourth color and which is defined in the second color gamut, and
in a case where the first color is included in the particular color information, correcting a conversion parameter in the color conversion processing such that a color obtained by converting the second color is a sixth color whose color difference from the third color is greater than the color difference between the third color and the fourth color and which is defined in the second color gamut.

22. A non-transitory computer-readable storage medium storing a program which, when executed by a computer comprising a processor and a memory, causes the computer to:
obtain first color information from an image that includes a pixel representing color information of a first color defined in a first color gamut and a pixel representing color information of a second color defined in the first color gamut;
set second color information indicating particular color information;
execute, on the image, color conversion processing for converting the first color into a third color defined in a second color gamut and converting the second color into a fourth color defined in the second color gamut; and
in a case where a color difference between the third color and the fourth color is less than a predetermined threshold,
in a case where the first color is not included in the particular color information, correct a conversion parameter in the color conversion processing such that a color obtained by converting the first color is a fifth color whose color difference from the fourth color is greater than the color difference between the third color and the fourth color and which is defined in the second color gamut, and
in a case where the first color is included in the particular color information, correct a conversion parameter in the color conversion processing such that a color obtained by converting the second color is a sixth color whose color difference from the third color is greater than the color difference between the third color and the fourth color and which is defined in the second color gamut.
